(19) United States
(12) Patent Application Publication
(10) Pub. No.: US 2011/0062012 A1
(43) Pub. Date: Mar. 17, 2011

(54) PROCESSES FOR HYDROMETHANATION OF A CARBONACEOUS FEEDSTOCK

(75) Inventor: Earl T. Robinson, Lakeland, FL (US)

(73) Assignee: GREATPOINT ENERGY, INC., Cambridge, MA (US)

(21) Appl. No.: 12/882,415

(22) Filed: Sep. 15, 2010

Related U.S. Application Data
(60) Provisional application No. 61/242,888, filed on Sep. 16, 2009.

(51) Int. Cl. C10L 3/08; B01J 8/00; C10B 57/12

(52) U.S. Cl. 201/2.5; 48/127.7; 48/127.9

(57) ABSTRACT

The present invention relates to processes for preparing gaseous products, and in particular methane and/other value added gases such as hydrogen, via the catalytic hydromethanation of a carbonaceous feedstock in the presence of steam and syngas, wherein a hydromethanation reactor is combined with a syngas generator in a particular combination.

### CROSS REFERENCE TO RELATED APPLICATION

This application claims priority under 35 U.S.C. §119 from U.S. Provisional Application Ser. No. 61/242,888 (filed 16 Sep. 2009), the disclosure of which is incorporated by reference herein for all purposes as if fully set forth.

### FIELD OF THE INVENTION

The present invention relates to processes for preparing gaseous products, and in particular methane and/or other value added gaseous products such as hydrogen, via the hydromethanation of carbonaceous feedstocks in the presence of steam, carbon monoxide, hydrogen and a hydromethanation catalyst.

### BACKGROUND OF THE INVENTION

In view of numerous factors such as higher energy prices and environmental concerns, the production of value-added gaseous products from lower-fuel-value carbonaceous feedstocks, such as petroleum coke, coal and biomass, is receiving renewed attention. The catalytic gasification of such materials to produce methane and other value-added gases is disclosed, for example, in U.S. Pat. No. 3,828,474, U.S. Pat. No. 3,998,607, U.S. Pat. No. 4,057,512, U.S. Pat. No. 4,092,125, U.S. Pat. No. 4,094,650, U.S. Pat. No. 4,204,843, U.S. Pat. No. 4,468,231, U.S. Pat. No. 4,500,323, U.S. Pat. No. 4,541,841, U.S. Pat. No. 4,551,155, U.S. Pat. No. 4,558,027, U.S. Pat. No. 4,606,105, U.S. Pat. No. 4,617,027, U.S. Pat. No. 4,609,456, U.S. Pat. No. 5,017,282, U.S. Pat. No. 5,055,181, U.S. Pat. No. 6,187,465, U.S. Pat. No. 6,790,430, U.S. Pat. No. 6,894,183, U.S. Pat. No. 6,955,695, US2003/0167961A1, US2006/0265953A1, US2007/000177A1, US2007/083072A1, US2007/0277437A1, US2009/0048476A1, US2009/0090056A1, US2009/0090055A1, US2009/0165383A1, US2009/0166588A1, US2009/0165379A1, US2009/0170968A1, US2009/0165380A1, US2009/0165381A1, US2009/0165361A1, US2009/0165382A1, US2009/0169449A1, US2009/0169448A1, US2009/0165376A1, US2009/0165384A1, US2009/0217584A1, US2009/0217585A1, US2009/0217590A1, US2009/0217586A1, US2009/0217588A1, US2009/0217589A1, US2009/0217575A1, US2009/0229182A1, US2009/0217587A1 and GB1599932.

In general, carbonaceous materials, such as coal, biomass, asphaltenes, liquid petroleum residues and/or petroleum coke, can be converted to a plurality of gases, including value-added gases such as methane, by the reaction of the material in the presence of a catalyst source and steam at elevated temperatures and pressures. Fine particles of unreacted carbonaceous materials are removed from the raw gas product, and the gases are cooled and scrubbed in multiple processes to remove side products such as hydrogen and carbon monoxide, and undesirable contaminants including carbon dioxide and hydrogen sulfide, to produce a methane product stream.

The hydromethanation of a carbon source to methane typically involves four separate reactions:

Steam carbon: C+H₂O→CO+H₂ (I)

Water-gas shift: CO+H₂O→H₂+CO₂ (II)

CO Methanation: CO+3H₂→CH₄+H₂O (III)

Hydro-gasification: 2H₂+C→CH₄ (IV)

In the hydromethanation reaction, the first three reactions (I-III) predominate to result in the following overall reaction:

2C+2H₂O→CH₄+CO₂ (V).

The result is a “direct” methane-enriched raw product gas stream, which can be subsequently purified to provide the final product. This is distinct from “conventional” carbon gasification processes, such as those based on partial combustion/oxidation of a carbon source, where a syngas is the primary product (little or no methane is directly produced), which can then be further processed to produce methane (via catalytic methanation, see reaction (III)) or any number of other higher hydrocarbon products. When methane is the desired end-product, therefore, the hydromethanation reaction provides the possibility for increased efficiency and lower methane cost than traditional gasification processes.

The overall reaction is essentially thermally balanced; however, due to process heat losses and other energy requirements (such as required for evaporation of moisture entering the reactor with the feedstock), some heat must be added to maintain the thermal balance.

The reactions are also essentially syngas (hydrogen and carbon monoxide) balanced (syngas is produced and consumed); therefore, as carbon monoxide and hydrogen are withdrawn with the product gases, carbon monoxide and hydrogen need to be added to the reaction as required to avoid a deficiency.

In order to maintain the net heat of reaction as close to neutral as possible (only slightly exothermic or endothermic), and maintain the syngas balance, a superheated gas stream of steam, carbon monoxide and hydrogen is often fed to the hydromethanation reactor. Frequently, the carbon monoxide and hydrogen streams are recycle streams separated from the product gas, and/or are provided by reforming a portion of the product methane. See, for example, U.S. Pat. No. 4,094,650, U.S. Pat. No. 6,955,595 and US2007/083072A1.

Gas recycle loops generally require at least additional heating elements (superheaters) and pressurization elements to bring the recycle gas stream to a temperature and pressure suitable for introduction into the catalytic gasifier. Further, the separation of the recycle gases from the methane product, for example by cryogenic distillation, and the reforming of the methane product, greatly increases the engineering complexity and overall cost of producing methane, and decreases the overall system efficiency.

Steam generation is another area that can increase the engineering complexity of the overall system. The use of externally fired boilers, for example, can greatly decrease overall system efficiency.

Therefore, a need remains for improved hydromethanation processes where gas recycle loops and superheaters are minimized and/or eliminated to decrease the complexity and cost of producing methane.

### SUMMARY OF THE INVENTION

In one aspect, the invention provides a process for generating a methane-enriched raw product stream and a syngas raw product stream from one or more carbonaceous feedstocks, the process comprising the steps of:

(a) supplying a first carbonaceous feedstock, a first oxygen-rich gas stream, and optionally an aqueous stream comprising one or both of water and steam, to a syngas generator;

(b) reacting the first carbonaceous feedstock in the presence of oxygen and optionally the aqueous stream, in the syngas generator to produce a first gas stream at a first temperature and a first pressure, the first gas stream comprising hydrogen, carbon monoxide, heat energy and optionally steam;

(c) introducing the first gas stream into a first heat exchanger unit, optionally with a quench stream comprising one or both of water and steam, to remove heat energy and generate a cooled first gas stream at a second temperature and a second pressure, the cooled first gas stream comprising hydrogen, carbon monoxide and optionally steam;

(d) separating the cooled first gas stream into a hydromethanation gas feed stream and the syngas raw product stream, the syngas raw product stream comprising carbon monoxide, hydrogen and optionally steam;

(e) optionally adding one or both of steam and heat energy to the hydromethanation gas feed stream such that the resulting hydromethanation gas feed stream comprises hydrogen, carbon monoxide and steam at a third temperature and a third pressure;

(f) introducing a second carbonaceous feedstock, a hydromethanation catalyst, the hydromethanation gas feed stream and optionally a second oxygen-rich gas stream, to a hydromethanation reactor;

(g) reacting the second carbonaceous feedstock in the hydromethanation reactor in the presence of carbon monoxide, hydrogen, steam, hydromethanation catalyst and optionally oxygen, at a fourth temperature and a fourth pressure, to produce the methane-enriched raw product stream, wherein the methane-enriched raw product stream comprises methane, carbon monoxide, hydrogen, carbon dioxide, hydrogen sulfide and heat energy; and

(h) withdrawing the methane-enriched product stream from the hydromethanation reactor,

wherein:
the reaction in step (g) has a syngas demand, a steam demand and a heat demand;
the amount of carbon monoxide and hydrogen in the hydromethanation gas feed stream (or the superheated hydromethanation gas feed stream if present) is sufficient to at least meet the syngas demand of the reaction in step (g);
if the amount of steam in the hydromethanation gas feed stream from step (d) is insufficient to meet the steam demand of the reaction in step (g), then step (e) is present and steam is added to the hydromethanation gas feed stream in an amount that is sufficient to at least meet the steam demand of the reaction in step (g);
if the second temperature is insufficient to meet the heat demand of the reaction in step (g), then step (e) is present and heat energy is added to the hydromethanation gas feed stream in an amount that is at least sufficient to meet the heat demand of the reaction in step (g).

The process in accordance with the present invention is useful, for example, for producing methane and/or other value-added gases (such as hydrogen) from various carbonaceous feedstocks.

In a second aspect, the invention provides a gasifier apparatus for generating a methane-enriched raw product stream and a syngas raw product stream from one or more carbonaceous feedstocks, the gasifier apparatus comprising:

(a) a syngas generator configured (1) to receive a first carbonaceous feedstock, a first oxygen-rich gas stream and, optionally an aqueous stream comprising one or both of water and steam; (2) to contain a reaction of the first carbonaceous feedstock in the presence of oxygen and optionally the aqueous stream, that produces a first gas stream comprising hydrogen, carbon monoxide and optionally steam, at a first temperature and a first pressure, and (3) to exhaust the first gas stream;

(b) a cooling zone configured to (1) receive the first gas stream and, optionally, a quench stream comprising one or both of steam and water, and (2) generate a cooled first gas stream comprising hydrogen, carbon monoxide and, optionally, steam at a second temperature and a second pressure;

(c) a separation zone configured to (1) receive the cooled first gas stream, and (2) separate the cooled first gas stream into a hydromethanation gas feed stream and the syngas raw product stream, the syngas raw product stream comprising carbon monoxide, hydrogen and optionally steam;

(d) an optional superheater zone configured to (1) receive the hydromethanation gas feed stream from the separation zone, (2) optionally receive a steam feed stream, and (3) generate a superheated hydromethanation gas feed stream comprising carbon monoxide, hydrogen and steam at a third temperature and a third pressure; and

(e) a hydromethanation reactor configured (1) to receive a second carbonaceous feedstock, a hydromethanation catalyst, the hydromethanation gas feed stream and, optionally, a second oxygen-rich gas stream, the second carbonaceous feedstock comprising a carbon content; (2) to contain a reaction of the second carbonaceous feedstock in the presence of carbon monoxide, hydrogen, steam, hydromethanation catalyst and optionally oxygen, at a fourth temperature and a fourth pressure, that produces a methane-enriched raw product stream, the methane-enriched raw product stream comprising methane, carbon monoxide, hydrogen and carbon dioxide; and (3) to exhaust the methane-enriched raw product stream.

In a third aspect, the invention provides processes for generating a sweetened gas stream from one or more carbonaceous feedstocks, the sweetened gas stream comprising methane, hydrogen and optionally carbon monoxide with substantially no carbon dioxide and hydrogen sulfide, the process comprising the steps of:

(A) providing an existing facility comprising (i) a syngas generator that produces a first gas stream comprising carbon monoxide and hydrogen, and optionally carbon dioxide, hydrogen sulfide and steam, at a first temperature and pressure, and (ii) a gas processing system comprising an acid gas removal unit for removing substantially all of the carbon dioxide and hydrogen sulfide that may be present in the first gas stream, wherein the syngas generator comprises an exhaust line for the first gas stream that ties into the gas processing system;

(B) modifying the existing facility to produce a modified facility comprising the following modifications:
(1) if the exhaust line does not comprise a cooling zone for cooling the first gas stream to produce a cooled first gas stream at a second temperature and second pressure, inserting such a cooling zone into the exhaust line prior to the gas processing system;
(2) inserting a gas stream splitting mechanism between the cooling zone and the gas processing system, the gas stream splitting mechanism configured to split the cooled first gas stream into a syngas raw product stream and a hydromethanation gas feed stream;
(3) optionally inserting a superheater for the hydromethanation gas feed stream in communication with the gas stream splitting mechanism, the superheater configured to generate a superheated hydromethanation gas feed stream at a third temperature and pressure;
(4) inserting a hydromethanation reactor in communication with the gas stream splitting mechanism (or the superheater if present), wherein the hydromethanation reactor is configured (i) to receive a second carbonaceous feedstock, a hydromethanation catalyst, the hydromethanation gas feed stream and, optionally, an oxygen-rich gas stream; (ii) to contain a reaction of the second carbonaceous feedstock in the presence of carbon monoxide, hydrogen, steam, hydromethanation catalyst and optionally oxygen, at a fourth temperature and a fourth pressure, that produces a methane-enriched raw product stream, the methane-enriched raw product stream comprising methane, carbon monoxide, hydrogen, carbon dioxide, hydrogen sulfide and heat energy; and (iii) to exhaust the methane-enriched raw product stream; and
(5) inserting a line to feed the methane-enriched product stream into the gas processing system;

(C) operating the process according to the first aspect of the invention in the modified facility; and

(D) processing the methane-enriched product stream and, optionally, at least a portion of the syngas raw product stream to produce the sweetened gas stream.

These and other embodiments, features and advantages of the present invention will be more readily understood by those of ordinary skill in the art from a reading of the following detailed description.

### BRIEF DESCRIPTION OF THE DRAWINGS

FIG. 1 is a diagram of an embodiment of a hydromethanation process in accordance with the present invention whereby a methane-enriched raw product stream and a syngas raw product stream are produced.

FIG. 2 is a diagram of a process for the further processing of the methane-enriched raw product stream and, optionally, the syngas raw product stream.

### DETAILED DESCRIPTION

The present disclosure relates to processes to convert a carbonaceous feedstock into a plurality of gaseous products including at least methane, the processes comprising, among other steps, providing a carbonaceous feedstock, a syngas stream (hydrogen and carbon monoxide) from a syngas generator, a hydromethanation catalyst and steam to a hydromethanation reactor to convert the carbonaceous feedstock in the presence of hydromethanation catalyst, carbon monoxide, hydrogen and steam into the plurality of gaseous products.

The present invention can be practiced in conjunction with the subject matter disclosed in commonly-owned US2007/0000177A1, US2007/0083072A1, US2007/0277437A1, US2009/0048476A1, US2009/0090056A1, US2009/0090055A1, US2009/0165383A1, US2009/0166588A1, US2009/0165379A1, US2009/0170968A1, US2009/0165380A1, US2009/0165381A1, US2009/0165361A1, US2009/0165382A1, US2009/0169449A1, US2009/0169448A1, US2009/0165376A1, US2009/0165384A1, US2009/0217582A1, US2009/0260287A1, US2009/0220406A1, US2009/0217590A1, US2009/0217586A1, US2009/0217588A1, US2009/0218424A1, US2009/0217589A1, US2009/0217575A1, US2009/0229182A1, US2009/0217587A1, US2009/0260287A1, US2009/0220406A1, US2009/0259080A1, US2009/0246120A1, US2009/0324458A1, US2009/0324459A1, US2009/0324460A1, US2009/0324461A1, US2009/0324462A1, US2010/0121125A1, US2010/0120926A1, US2010/0071262A1, US2010/0076235A1, US2010/0179232A1, US2010/0168495A1 and US2010/0168494A1.

Moreover, the present invention can be practiced in conjunction with the subject matter disclosed in commonly-owned U.S. patent application Ser. Nos. 12/778,538 (attorney docket no. FN-0047 US NP1, entitled PROCESS FOR HYDROMETHANATION OF A CARBONACEOUS FEEDSTOCK), and 12/778,548 (attorney docket no. FN-0048 US NP1, entitled PROCESSES FOR HYDROMETHANATION OF A CARBONACEOUS FEEDSTOCK), each of which was filed 12 May 2010; and 12/851,864 (attorney docket no. FN-0050 US NP1, entitled PROCESSES FOR HYDROMETHANATION OF A CARBONACEOUS FEEDSTOCK), which was filed 6 Aug. 2010.

All publications, patent applications, patents and other references mentioned herein, including but not limited to those referenced above, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Although methods and materials similar or equivalent to those described herein can be used in the practice or testing of the present disclosure, suitable methods and materials are described herein.

Unless stated otherwise, all percentages, parts, ratios, etc., are by weight.

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

The term “substantial portion”, as used herein, unless otherwise defined herein, means that greater than about 90% of the referenced material, preferably greater than 95% of the referenced material, and more preferably greater than 97% of the referenced material. The percent is on a molar basis when reference is made to a molecule (such as methane, carbon dioxide, carbon monoxide and hydrogen sulfide), and otherwise is on a weight basis (such as for entrained carbonaceous fines).

The term “carbonaceous material” as used herein can be, for example, biomass and non-biomass materials as defined herein.

The term “biomass” as used herein refers to carbonaceous materials derived from recently (for example, within the past 100 years) living organisms, including plant-based biomass and animal-based biomass. For clarification, biomass does not include fossil-based carbonaceous materials, such as coal. For example, see previously incorporated US2009/0217575A1, US2009/0229182A1 and US2009/0217587A1.

The term “plant-based biomass” as used herein means materials derived from green plants, crops, algae, and trees, such as, but not limited to, sweet sorghum, bagasse, sugarcane, bamboo, hybrid poplar, hybrid willow, albizia trees, eucalyptus, alfalfa, clover, oil palm, switchgrass, sudangrass, millet, jatropha, and miscanthus (e.g., Miscanthus×giganteus). Biomass further include wastes from agricultural cultivation, processing, and/or degradation such as corn cobs and husks, corn stover, straw, nut shells, vegetable oils, canola oil, rapeseed oil, biodiesels, tree bark, wood chips, sawdust, and yard wastes.

The term “animal-based biomass” as used herein means wastes generated from animal cultivation and/or utilization. For example, biomass includes, but is not limited to, wastes from livestock cultivation and processing such as animal manure, guano, poultry litter, animal fats, and municipal solid wastes (e.g., sewage).

The term “non-biomass”, as used herein, means those carbonaceous materials which are not encompassed by the term “biomass” as defined herein. For example, non-biomass include, but is not limited to, anthracite, bituminous coal, sub-bituminous coal, lignite, petroleum coke, asphaltenes, liquid petroleum residues or mixtures thereof. For example, see previously incorporated US2009/0166588A1, US2009/0165379A1, US2009/0165380A1, US2009/0165361A1, US2009/0217590A1 and US2009/0217586A1.

The terms “petroleum coke” and “petcoke” as used here includes both (i) the solid thermal decomposition product of high-boiling hydrocarbon fractions obtained in petroleum processing (heavy residues—“resid petcoke”); and (ii) the solid thermal decomposition product of processing tar sands (bituminous sands or oil sands—“tar sands petcoke”). Such carbonization products include, for example, green, calcined, needle and fluidized bed petcoke.

Resid petcoke can also be derived from a crude oil, for example, by coking processes used for upgrading heavy-gravity residual crude oil, which petcoke contains ash as a minor component, typically about 1.0 wt % or less, and more typically about 0.5 wt % of less, based on the weight of the coke. Typically, the ash in such lower-ash cokes comprises metals such as nickel and vanadium.

Tar sands petcoke can be derived from an oil sand, for example, by coking processes used for upgrading oil sand. Tar sands petcoke contains ash as a minor component, typically in the range of about 2 wt % to about 12 wt %, and more typically in the range of about 4 wt % to about 12 wt %, based on the overall weight of the tar sands petcoke. Typically, the ash in such higher-ash cokes comprises materials such as silica and/or alumina.

Petroleum coke has an inherently low moisture content, typically, in the range of from about 0.2 to about 2 wt % (based on total petroleum coke weight); it also typically has a very low water soaking capacity to allow for conventional catalyst impregnation methods. The resulting particulate compositions contain, for example, a lower average moisture content which increases the efficiency of downstream drying operation versus conventional drying operations.

The petroleum coke can comprise at least about 70 wt % carbon, at least about 80 wt % carbon, or at least about 90 wt % carbon, based on the total weight of the petroleum coke. Typically, the petroleum coke comprises less than about 20 wt % inorganic compounds, based on the weight of the petroleum coke.

The term “asphaltene” as used herein is an aromatic carbonaceous solid at room temperature, and can be derived, from example, from the processing of crude oil and crude oil tar sands.

The term “coal” as used herein means peat, lignite, sub-bituminous coal, bituminous coal, anthracite, or mixtures thereof. In certain embodiments, the coal has a carbon content of less than about 85%, or less than about 80%, or less than about 75%, or less than about 70%, or less than about 65%, or less than about 60%, or less than about 55%, or less than about 50% by weight, based on the total coal weight. In other embodiments, the coal has a carbon content ranging up to about 85%, or up to about 80%, or up to about 75% by weight, based on the total coal weight. Examples of useful coal include, but are not limited to, Illinois #6, Pittsburgh #8, Beulah (ND), Utah Blind Canyon, and Powder River Basin (PRB) coals. Anthracite, bituminous coal, sub-bituminous coal, and lignite coal may contain about 10 wt %, from about 5 to about 7 wt %, from about 4 to about 8 wt %, and from about 9 to about 11 wt %, ash by total weight of the coal on a dry basis, respectively. However, the ash content of any particular coal source will depend on the rank and source of the coal, as is familiar to those skilled in the art. See, for example, “Coal Data: A Reference”, Energy Information Administration, Office of Coal, Nuclear, Electric and Alternate Fuels, U.S. Department of Energy, DOE/EIA-0064(93), February 1995.

The ash produced from combustion of a coal typically comprises both a fly ash and a bottom ash, as are familiar to those skilled in the art. The fly ash from a bituminous coal can comprise from about 20 to about 60 wt % silica and from about 5 to about 35 wt % alumina, based on the total weight of the fly ash. The fly ash from a sub-bituminous coal can comprise from about 40 to about 60 wt % silica and from about 20 to about 30 wt % alumina, based on the total weight of the fly ash. The fly ash from a lignite coal can comprise from about 15 to about 45 wt % silica and from about 20 to about 25 wt % alumina, based on the total weight of the fly ash. See, for example, Meyers, et al. “Fly Ash. A Highway Construction Material,” Federal Highway Administration, Report No. FHWA-IP-76-16, Washington, D.C., 1976.

The bottom ash from a bituminous coal can comprise from about 40 to about 60 wt % silica and from about 20 to about 30 wt % alumina, based on the total weight of the bottom ash. The bottom ash from a sub-bituminous coal can comprise from about 40 to about 50 wt % silica and from about 15 to about 25 wt % alumina, based on the total weight of the bottom ash. The bottom ash from a lignite coal can comprise from about 30 to about 80 wt % silica and from about 10 to about 20 wt % alumina, based on the total weight of the bottom ash. See, for example, Moulton, Lyle K. “Bottom Ash and Boiler Slag,” Proceedings of the Third International Ash Utilization Symposium, U.S. Bureau of Mines, Information Circular No. 8640, Washington, D.C., 1973.

The term “unit” refers to a unit operation. When more than one “unit” is described as being present, those units are operated in a parallel fashion. A single “unit”, however, may comprise more than one of the units in series. For example, an acid gas removal unit may comprise a hydrogen sulfide removal unit followed in series by a carbon dioxide removal unit. As another example, a trace contaminant removal unit may comprise a first removal unit for a first trace contaminant followed in series by a second removal unit for a second trace contaminant. As yet another example, a methane compressor unit may comprise a first methane compressor to compress the methane product stream to a first pressure, followed in series by a second methane compressor to further compress the methane product stream to a second (higher) pressure.

The term “syngas demand” refers to the maintenance of syngas balance in the hydromethanation reactor. As discussed above, in the overall desirable steady-state hydromethanation reaction (see equations (I), (II) and (III) above), hydrogen and carbon monoxide are generated and consumed in balance. Because both hydrogen and carbon monoxide are withdrawn as part of the gaseous products, hydrogen and carbon monoxide must be added to (and/or optionally separately generated in situ via a combustion/oxidation reaction with supplied oxygen) the hydromethanation reactor in an amount at least required to maintain this reaction balance. For the purposes of the present invention, the amount of hydrogen and carbon monoxide that must be added to the hydromethanation reactor is the “syngas demand” (excluding separate in situ syngas generation).

The term “steam demand” refers to the amount of steam that must be added to the hydromethanation reactor. Steam is consumed in the hydromethanation reaction and must be added to the hydromethanation reactor. The theoretical consumption of steam is two moles for every two moles of carbon in the feed to produce one mole of methane and one mole of carbon dioxide (see equation (V)). In actual practice, the steam consumption is not perfectly efficient and steam is withdrawn with the product gases; therefore, a greater than theoretical amount of steam needs to be added to the hydromethanation reactor, which amount is the “steam demand”. Steam can be added, for example, via steam in the hydromethanation gas feed stream, steam in the second oxygen-rich gas stream (if present), steam generated in situ from any moisture content of the carbonaceous feedstock, and as a separate steam stream. The amount of steam to be added (and the source) is discussed in further detail below. It should be noted that any steam that is generated in situ or that is fed into the hydromethanation reactor at a temperature lower than the hydromethanation reaction temperature will have an impact on the “heat demand” for the hydromethanation reaction.

The term “heat demand” refers to the amount of heat energy that must be added to the hydromethanation reactor to keep the reaction of step (g) in thermal balance, as discussed above and as further detailed below.

The materials, methods, and examples herein are illustrative only and, except as specifically stated, are not intended to be limiting.

### Examples of Specific Embodiments

A specific embodiment of the process is one in which a methane product stream is produced, desirably of “pipeline-quality natural gas”.

Another specific embodiment is one in which a hydrogen product stream is produced.

Another specific embodiment is one in which the methane-enriched raw product stream and, optionally, at least a portion of the syngas raw product stream (the methane-enriched raw product stream and syngas raw product stream (or portion) together are sometimes referred to as the “combined raw product stream”), are treated in a gas processing system to produce a sweetened gas stream, which can be further processed to produce the methane product stream and/or the hydrogen product stream. Such treatment, for example, comprises the following steps:

(i) introducing the methane-enriched raw product stream (or the combined raw product stream if present) into a second heat exchanger unit to recover heat energy and generate a cooled raw product stream (or cooled combined raw product stream);

(j) optionally sour shifting a portion of the carbon monoxide in the cooled raw product stream to generate heat energy and a hydrogen-enriched raw product stream;

(k) optionally introducing the hydrogen-enriched raw product stream into a third heat exchanger unit to recover heat energy;

(l) optionally reacting a portion of the hydrogen and at least a portion of the carbon monoxide in the cooled raw product stream (or the hydrogen-enriched raw product stream if present) in a catalytic methanator in the presence of a sulfur-tolerant methanation catalyst to generate heat energy and a methane-enriched treated raw product stream;

(m) optionally introducing the methane-enriched treated raw product stream into a fourth heat exchanger unit to recover heat energy;

(n) removing a substantial portion of the carbon dioxide and a substantial portion of the hydrogen sulfide from the cooled raw product stream (or the hydrogen-enriched raw product stream if present, or the methane-enriched treated raw product stream if present) to produce a sweetened gas stream comprising a substantial portion of the hydrogen, carbon monoxide and methane from the cooled raw product stream (or the hydrogen-enriched raw product stream if present, or the methane-enriched treated raw product stream if present);

(o) optionally separating a portion of the hydrogen from the sweetened gas stream to produce a hydrogen product stream and a hydrogen-depleted sweetened product gas stream comprising methane, optionally carbon monoxide and optionally hydrogen;

(p) optionally reacting carbon monoxide and hydrogen present in the sweetened product gas stream (or hydrogen-depleted sweetened product gas stream if present) in a catalytic methanator in the presence of a methanation catalyst to generate heat energy and a methane-enriched sweetened product gas stream;

(q) optionally introducing the methane-enriched sweetened product gas stream into a fifth heat exchanger unit to recover heat energy; and

(r) optionally recovering at least a portion of the methane-enriched sweetened product gas stream as the methane product stream.

In another embodiment, the heat energy removed in the first, second (if present), third (if present), fourth (if present) and fifth (if present) heat exchanger units is recovered through the generation of one or more process steam streams, and/or through the heating/superheating of one or more process streams. For example, the heat energy recovered in the first heat exchanger unit can be used to superheat the hydromethanation gas feed stream prior to introduction into the hydromethanation reactor, and/or generate a first process steam stream; the heat energy recovered in the second heat exchanger unit (if present) can be used to generate a second process steam stream, and/or superheat the second or another process steam stream; the heat energy recovered in the third heat exchanger unit (if present) can be used to preheat boiler feed water used to generate process steam in, for example, one or more of the first, second, fourth and fifth heat exchanger units, and/or superheat the cooled raw product stream prior to introduction into step (j) (into a sour shift unit); and the heat energy recovered in the fourth and fifth heat exchanger units (if present) can be used to generate a third and fourth process steam stream.

Desirably, any steam fed into the syngas generator and the hydromethanation reaction, and used as a quench stream, is substantially made up from at least a portion of one or more of the process steam streams generated from process heat recovery.

Another specific embodiment is one in which the process steam streams from the first, second (when present), fourth (when present) and fifth (when present) heat exchanger units are generated at a pressure higher than the pressure in the hydromethanation reactor. The pressure of the process steam streams should be high enough above the pressure in the hydromethanation reactor such that no additional compression is necessary.

Another specific embodiment is one in which the process is a continuous process, in which steps (a), (b), (c), (d), (g) and (h), and when present, (e) and (i-r), are operated in a continuous manner.

Another specific embodiment is one in which the second oxygen-rich gas stream is supplied periodically or continuously to the hydromethanation reactor, and the amount of oxygen provided is varied as a process control, for example, to assist control of the temperature in the hydromethanation reactor. As oxygen is supplied to the hydromethanation reactor, carbon from the feedstock (for example in the by-product char) is partially oxidized/combusted to generate heat energy (as well as typically some amounts of carbon monoxide and hydrogen). The amount of oxygen supplied to the hydromethanation reactor can be increased or decreased to increase the amount of carbon being consumed and, consequently, the amount of heat energy being generated, in situ in the hydromethanation reactor. In such a case, this heat energy generated in situ reduces the heat demand of the reaction in step (g), and thus the amount of heat energy supplied in the hydromethanation feed gas stream.

Another specific embodiment is one in which the second oxygen-rich gas stream is supplied periodically or continuously to the hydromethanation reactor, the second oxygen-rich gas stream comprises steam, and the steam in the second oxygen-rich gas stream is substantially made up from at least a portion of one or more of the process steam streams.

Another specific embodiment is one in which fired superheaters (for example, carbon fuel fired superheaters) are desirably eliminated from the processes, since the hydromethanation gas feed stream may be superheated to a desired feed temperature and pressure through one or more stages of process heat recovery.

Another specific embodiment is one in which a char by-product is generated in step (g), wherein the char by-product is periodically or continuously withdrawn from the hydromethanation reactor, and at least a portion of the withdrawn by-product char is provided to a catalyst recovery operation. Recovered catalyst is then recycled and combined with makeup catalyst to meet the demands of the hydromethanation reaction.

Another specific embodiment is one in which a char by-product is generated in step (g), the hydromethanation reactor comprises a collection zone where the char by-product collects, the second oxygen-rich gas stream is supplied to the hydromethanation reactor, and the second oxygen-rich gas stream is introduced into the char by-product collection zone of the hydromethanation reactor. As the by-product char comprises carbon content from the carbonaceous feedstock, the char carbon is desirably preferentially consumed to generate heat energy (and typically some amounts of carbon monoxide and hydrogen).

In another specific embodiment of the first aspect, at least a portion of the syngas raw product stream is co-processed with the methane-enriched raw product steam. The methane-enriched raw product stream and the syngas raw product stream can be combined, for example, before step (i), as part of step (i), or after step (i) and before step (j).

Another specific embodiment of the first aspect is one which is a once-through process, in which there is no recycle of carbon monoxide or hydrogen from the methane-enriched raw product stream or syngas raw product stream. In other words, the syngas (carbon monoxide and hydrogen) requirements of the hydromethanation reaction are fully satisfied by the syngas generator.

In another specific embodiment, the first carbonaceous feedstock comprises an ash content, the first gas stream comprises a residue from the ash content, and the residue from the ash content is substantially removed prior to introduction of the hydromethanation gas feed stream into the hydromethanation reactor.

In a specific embodiment of the second aspect, the apparatus further comprises a gas processing system configured to receive the methane-enriched raw product stream and, optionally, at least a portion of the syngas raw product stream, and output a sweetened gas stream comprising methane, hydrogen and optionally carbon monoxide with substantially no carbon dioxide or hydrogen sulfide.

In another specific embodiment of the second aspect, the gas processing system comprises:

(1) a second heat recovery unit configured to recover process heat energy from the methane-enriched raw product stream and generate a cooled methane-enriched raw product stream;

(2) an optional ammonia recovery unit subsequent to the first heat recovery unit to produce an ammonia-depleted raw product stream;

(3) an optional sour shift reactor subsequent to the first heat recovery unit configured to sour shift at least a portion of carbon monoxide in the methane-enriched raw product stream to generate heat energy and a hydrogen-enriched raw product stream;

(4) if the sour shift reactor is present, a third heat recovery unit in communication with the sour shift reactor to recover heat energy from the sour shift reactor, the hydrogen-enriched raw product stream or both;

(5) an optional sulfur-tolerant catalytic methanation reactor subsequent to the first heat recovery unit (and, if present, the sour shift reactor), to react at least a portion of the carbon monoxide and at least a portion of the hydrogen present in the methane-enriched raw product stream (or hydrogen-enriched raw product stream if present), to produce heat energy and a methane-enriched treated raw product stream;

(6) an acid gas remover unit subsequent to the first heat recovery unit (and, if present, the sour shift reactor and the sulfur-tolerant catalytic methanation reactor), to remove at least a substantial portion of the carbon dioxide and at least a substantial portion of the hydrogen sulfide from the methane-enriched raw product stream (or, if present, the hydrogen-enriched or second methane-enriched raw product stream) and generate a sweetened gas stream;

(7) a hydrogen separation unit to remove at least a portion of the hydrogen from the sweetened gas stream and generate a hydrogen product stream and a hydrogen-depleted sweetened gas stream;

(8) an optional catalytic methanation reactor subsequent to the acid gas remover unit to react a substantial portion of the carbon monoxide and at least a portion of the hydrogen from the sweetened product stream, and generate process heat energy and a methane-enriched sweetened product stream;

(9) if the catalytic methanation reactor is present, a third heat recovery unit to recover process heat energy from the catalytic methanation reactor, the methane-enriched sweetened product stream or both, and generate steam; and

(10) a methane separation unit to separate and recover methane from the sweetened product stream (or, if present, the methane-enriched sweetened product stream).

Reference to “raw product stream” above can be the methane-enriched raw product stream, or a combination with all or a part of the syngas raw product stream (combined raw product stream).

In a specific embodiment of the third aspect, the processing step (D) is as set forth for the first aspect.

In another specific embodiment of the second and third aspects, the hydromethanation reactor is further configured to receive the second oxygen-rich gas stream.

These specific examples of embodiments, as well as other materials, methods and examples herein, are illustrative only and, except as specifically stated, are not intended to be limiting on the broader aspects of the invention.

### General Process Information

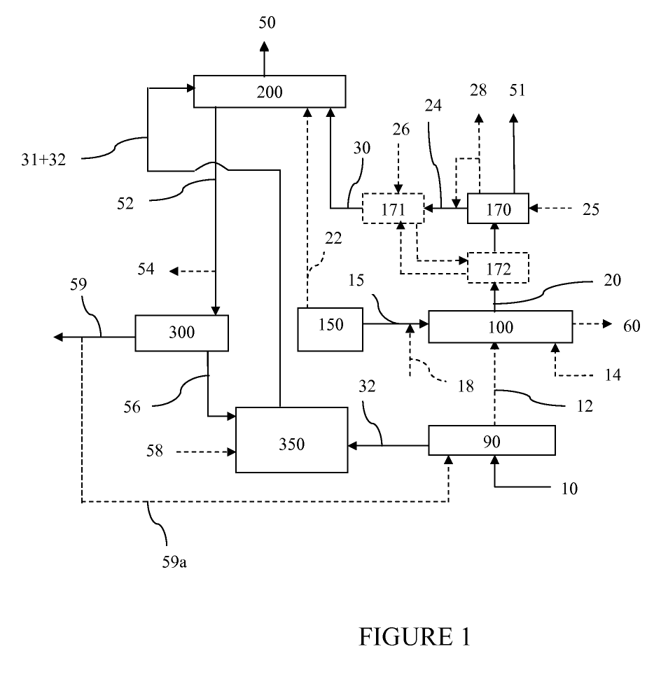

In one embodiment of the invention, a methane-enriched raw product stream (50) and a syngas raw product stream (51) can be generated from a carbonaceous feedstock as illustrated in FIG. 1.

A first carbonaceous feedstock (12) (which can be a methane-rich gas stream (14) as discussed below), a first oxygen-rich gas stream (15) (such as purified oxygen) and an optional steam stream (18) are provided to a syngas generator (100).

The syngas generator (100) is typically a partial oxidation/combustion gasification reactor (such as an oxygen-blown gasifier) in which the first carbonaceous feedstock (12) can be gasified (e.g., at least partially oxidized/combusted), under suitable temperature and pressure, to generate a first gas stream (20) comprising carbon monoxide and hydrogen. The first gas stream (20) will also comprise superheated steam if steam stream (18) is provided, and/or if the first carbonaceous feedstock (12) has a water content, such as in the form of an aqueous slurry. As described generally above, and more particularly below, a portion of the first gas stream (20) is used as an input for a hydromethanation process.

A second carbonaceous feedstock (32), a hydromethanation catalyst (31), an optional second oxygen-rich gas stream (22) and a hydromethanation feed stream (30) (comprising carbon monoxide, hydrogen and steam, derived from a portion of the first gas stream (20)) are provided to a hydromethanation reactor (200) that is in communication with the syngas generator (100). The second carbonaceous feedstock (32), carbon monoxide, hydrogen, steam and optional oxygen are reacted in the hydromethanation reactor (200) in the presence of a hydromethanation catalyst (31), and under suitable pressure and temperature conditions, to form the methane-enriched raw product stream (50), which comprises methane and a plurality of other gaseous products typically including hydrogen and carbon monoxide, as well as carbon dioxide, hydrogen sulfide and certain other contaminants primarily depending on the particular feedstock utilized.

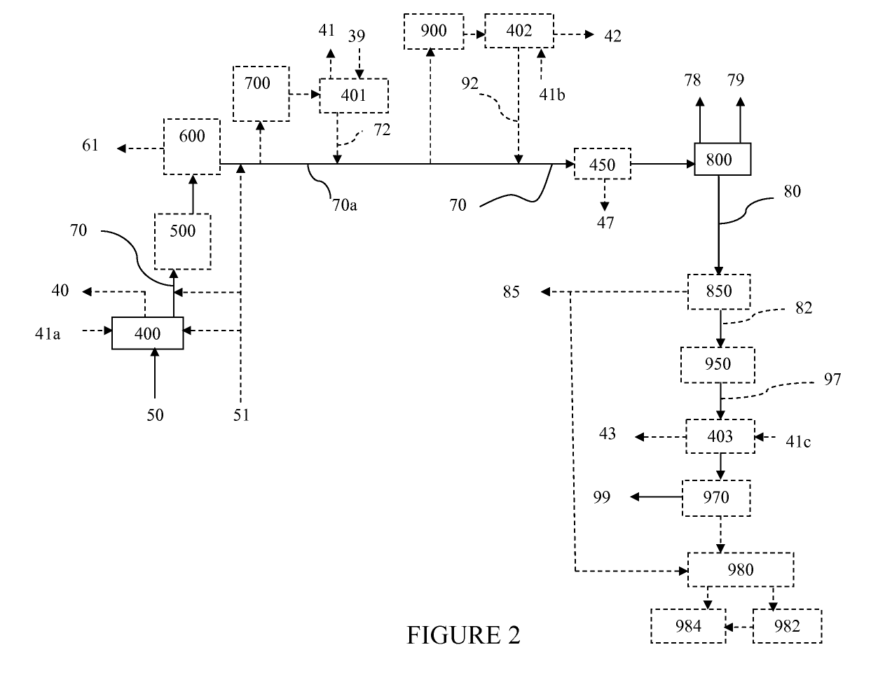

The first and second carbonaceous feedstocks (12, 32) are derived from one or more carbonaceous materials (10), which are processed in a feedstock preparation section (90) as discussed below. The second carbonaceous feedstock (32) can be from the same or different carbonaceous material(s) as the first carbonaceous feedstock (12). The first carbonaceous feedstock can also be a methane-rich stream (14), for example, all or a portion of a sweetened gas stream (80, FIG. 2), a hydrogen-depleted sweetened gas stream (82, FIG. 2), a methane-enriched sweetened as stream (97, FIG. 2), or a methane product stream (99, FIG. 2), as discussed below.

The hydromethanation catalyst (31) can comprise one or more catalyst species, as discussed below.

The second carbonaceous feedstock (32) and the hydromethanation catalyst (31) can be intimately mixed (i.e., to provide a catalyzed second carbonaceous feedstock (31+32)) before provision to the hydromethanation reactor (200).

The reactors (i.e., hydromethanation reactors and syngas generators) for the present processes are typically operated at high or moderately high pressures and temperatures (with the syngas generator typically being operated at a higher pressure and temperature than the hydromethanation reactor), requiring introduction of the appropriate carbonaceous feedstock to a reaction chamber of the reactor while maintaining the required temperature, pressure and flow rate of the feedstock. Those skilled in the art are familiar with feed inlets to supply the carbonaceous feedstock into the reaction chambers having high pressure and/or temperature environments, including star feeders, screw feeders, rotary pistons and lock-hoppers. It should be understood that the feed inlets can include two or more pressure-balanced elements, such as lock hoppers, which would be used alternately. In some instances, the carbonaceous feedstock can be prepared at pressure conditions above the operating pressure of the reactor and, hence, the particulate composition can be directly passed into the reactor without further pressurization.

Any of several types of gasification reactors can be utilized for either the hydromethanation reactor or the syngas generator. Suitable gasification reactors include those having a reaction chamber which is a counter-current fixed bed, a co-current fixed bed, a fluidized bed, or an entrained flow or moving bed reaction chamber. The hydromethanation reactor (200) is typically a fluidized bed reactor. The syngas generator (100) can be a non-catalytic reactor (such as a gas POx reactor) or a catalytic reactor (such as an autothermal reformer) when a methane-rich gas feed (14) is utilized.

Gasification—Syngas Generator (100)

In the syngas generator (100), the first carbonaceous feedstock (12) is reacted (partially oxidized or combusted), under suitable temperature and pressure conditions to generate the first gas stream (20).

When the first carbonaceous feedstock (12) is not a gas (solid, semisolid or liquid), the gasification in the syngas generator (100) will typically occur in a fluidized bed of the carbonaceous feedstock that is fluidized by the upward flow of the oxygen-rich and steam streams (15+18).

Typically, the gasification in the syngas generator (100) is a non-catalytic process, so no gasification catalyst needs to be added to the first carbonaceous feedstock (12) or into the syngas generator (100); however, a catalyst that promotes syngas formation may be utilized such as in, for example, an autothermal reformer.

Generally, when the first carbonaceous feedstock (12) comprises an ash content, the syngas generator (100) can be operated under non-slagging conditions to minimize the passing of ash by-product and other contaminants into the hydromethanation reactor (200). The operating temperature (i.e., the first temperature) in a non-slagging regime thus will be below the ash fusion point of the ash in the first carbonaceous feedstock (12), which can readily be determined by a person of ordinary skill in the relevant art. Typically, in a non-slagging operating regime, the syngas generator (100) will be operated at least about 100° F. (at least about 56° C.), or at least about 150° F. (at least about 83° C.), or at least about 200° F. (at least about 111° C.), below such ash fusion point. For example, for a feedstock having an ash fusion point of about 1800° F. (about 982° C.), the syngas generator (100) would be operated at about 1700° F. (about 927° C.) or less.

In certain embodiments, however, the syngas generator (100) may be operated under slagging conditions, for example, when higher temperatures and pressures are required than can be provided by a non-slagging regime. Under slagging conditions, the syngas generator (100) will be operated at a temperature above the ash fusion point of the ash in the first carbonaceous feedstock (12), which can readily be determined by a person of ordinary skill in the relevant art. Typically, in a slagging regime, the syngas generator (100) will be operated at least about 100° F. (at least about 56° C.), or at least about 150° F. (at least about 83° C.), or at least about 200° F. (at least about 111° C.), above such ash fusion point. For example, for a feedstock having an ash fusion point of about 1800° F. (about 982° C.), the gasification zone would be operated at about 1900° F. (about 1038° C.) or more.

The syngas generator (100) is typically operated at a temperature (i.e., the first temperature) of at least about 250° F. (at least about 139° C.), or at least about 350° F. (at least about 194° C.), or at least about 450° F. (at least about 250° C.), or at least about 500° F. (at least about 278° C.), higher than the hydromethanation reactor (200). That is, the first temperature is at least about 250° F. (at least about 139° C.), or at least about 350° F. (at least about 194° C.), or at least about 450° F. (at least about 250° C.), or at least about 500° F. (at least about 278° C.), higher than the third temperature.

The syngas generator (100) will also typically be operated at a higher pressure than the hydromethanation reactor (200) so that the hydromethanation feed stream (30) can be generated and fed to the hydromethanation reactor (200) without additional pressurization, even with intermediate processing. Typically, the pressure in the syngas generator (100) will be at least about 50 psi (about 345 kPa), or at least about 100 psi (about 690 kPa), or at least about 200 psi (about 1379 kPa), higher than the pressure in the hydromethanation reactor (200). That is, the first pressure is at least about 50 psi (about 345 kPa), or at least about 100 psi (about 690 kPa), or at least about 200 psi (about 1379 kPa), higher than the fourth pressure.

The temperature in the syngas generator (100) can be controlled, for example, by controlling the amount of oxygen, as well as the amount and temperature of steam or water, supplied to syngas generator (100), and/or by the moisture content of the first carbonaceous feedstock (12).

The first oxygen-rich gas stream (15) can be fed into the syngas generator (100) by any suitable means such as direct injection of purified oxygen, oxygen-air mixtures, oxygen-steam mixtures or oxygen-inert gas mixtures into the reactor bottom. See, for instance, U.S. Pat. No. 4,315,753 and Chiaramonte et al., Hydrocarbon Processing, September 1982, pp. 255-257. The first oxygen-rich gas stream (15) is typically generated via standard air-separation technologies, represented by air separation unit (150), and is typically fed as a high-purity oxygen stream (about 95% or greater volume percent oxygen).

The steam stream (18) and the first oxygen-rich gas stream (15) may be provided via a single stream or separate streams, and are generally provided at a temperature of from about 400° F. (about 204° C.), or from about 450° F. (about 232° C.), or from about 500° F. (about 260° C.), to about 750° F. (about 399° C.), or to about 700° F. (about 371° C.), or to about 650° F. (about 343° C.), and at a pressure at least slightly higher than present in the syngas generator (100). Generally, the first oxygen-rich gas stream (15) can be introduced as an admixture with the steam stream (18) into the reaction zone in order to assist in pressurization, fluidization and the partial combustion of carbonaceous feedstock particles, and to avoid formation of hot spots.

The first gas stream (20) is separated into the syngas raw product stream (51) and a cooled syngas stream (24) that is ultimately fed into hydromethanation reactor (200); however, the temperature of the first gas stream (20) exiting from the syngas generator (100) is too high for reliable operation of conventional gas valving/separation devices, so the first gas stream (20) is fed to a cooling device such as a first heat exchanger unit (170) to remove heat energy and reduce its temperature. The first heat exchanger unit (170) will typically be utilized to reduce the temperature of first gas stream (20) to a second temperature of about 700° F. or less (about 371° C. or less), or about 600° F. or less (about 316° C. or less), or about 500° F. or less (about 260° C. or less).

Typically, the first heat exchanger unit (170) will be used to recover heat energy from the first gas stream (20) to generate steam (28), which can be fed to the hydromethanation reactor (200) (for example, via combination with stream (24)) and/or otherwise used as recycle steam.

In one embodiment, the first heat exchanger unit (170) is a quench zone where an aqueous quench stream (25) comprising water and/or steam is contacted with the first gas stream (20) to adjust the first gas stream (20) to the appropriate temperature, steam content and other conditions required for the hydromethanation reaction, resulting in a quenched gas stream (24). This quenching may also assist with particulate/contaminant control as discussed in more detail below.

In addition to hydrogen, carbon monoxide and optional steam, the first gas stream (20) can include entrained particulates or molten slag, particularly when the syngas generator (100) is operated under slagging conditions. These particulates (including ash, char, carbonaceous fines, etc.) and slag (including molten ash and metallic components) are usually generated during partial combustion of the first carbonaceous feedstock (12) in the syngas generator (100). The particulates and molten slag can interfere with the hydromethanation process and downstream equipment; therefore, in some embodiments of the invention, a capture device (not depicted), such as a high-temperature filter device, is provided between the syngas generator (100) and the heat exchanger (170) and/or hydromethanation reactor (200) to remove a substantial portion or all of the particulates and slag present in part or all of the first gas stream (20) prior its introduction into hydromethanation reactor (200). Suitable removal devices include, without limitation, high temperature resistant screen mesh materials known in the art, and filters, including for example ceramic and high-temperature resistant metallic filters, moving-bed granular filters and multi-clone devices.

As indicated above, the quenching of first gas stream (20) with an aqueous quench stream (25) can assist in cleaning the first gas stream (20) of undesirable particulates and/or molten slag through, for example, temperature and/or gas velocity reduction.

Also, in addition to hydrogen, carbon monoxide and superheated steam, the first gas stream may contain other gases resulting from the reactions and/or fluidization conditions in the syngas generator (100), such as carbon dioxide. Because the gasification in the syngas generator (100) typically produces little or no methane directly, the first gas stream (20) will contain little or no methane (substantially no methane), for example, less than about 5 mol %, or less than about 2 mole %, or less than about 1 mol %, methane based on the moles of methane, carbon dioxide, carbon monoxide and hydrogen in the first gas stream (20).

Generally, the first gas stream (20) contains both carbon monoxide and hydrogen in excess of the amounts required for the hydromethanation reaction. In certain embodiments, the first gas stream (20) contains at least about a 25 mol % excess, or at least about a 100 mol % excess, of the demand for both carbon monoxide and hydrogen of the hydromethanation reaction.

Steam may be supplied to the syngas generator (100) and heat exchanger (170) by any of the steam boilers known to those skilled in the art. Such boilers can be powered, for example, through the use of any carbonaceous material such as powdered coal, biomass etc., and including but not limited to rejected carbonaceous materials from the feedstock preparation operations (e.g., fines, supra). Steam can also be supplied from an additional gasifier coupled to a combustion turbine where the exhaust from the reactor is thermally exchanged to a water source to produce steam (for example, in a waste heat recovery boiler).

Advantageously, steam is supplied by recycle and/or is generated from other process operations through process heat capture (such as generated in a waste heat boiler, generally referred to as “recycle steam”) and, in some embodiments, is solely supplied as recycle steam to the syngas generator (100), and solely used as the aqueous quench stream (25). For example, when carbonaceous materials are dried with a fluid bed slurry drier, as discussed below for the preparation of the carbonaceous feedstocks (12,32), the steam generated through vaporization can be fed to the syngas generator (100) and/or first heat exchanger unit (170). Further, steam generated by a heat exchanger unit or waste heat boiler (such as, for example, 170 in FIG. 1, and 400, 402 and/or 403 in FIG. 2) can be fed to the syngas generator (100) and/or back to first heat exchanger unit (170) as the quench stream (25).

In certain embodiments, the overall process described herein for the generation of the methane-enriched raw product stream (50) and syngas raw product stream (51) is steam neutral, such that steam demand (pressure and amount) can be satisfied via heat exchange with process heat at the different stages therein, or steam positive, such that excess steam is produced and can be used, for example, for power generation.

If the first carbonaceous feedstock (12) comprises an ash content, the reaction in the syngas generator (100) also results in an ash by-product (60), which may be periodically or continuously removed from the syngas generator (100). Typically, the ash by-product (60) will have residual carbon contents of about 5 wt % or less, or about 3 wt % or less, or about 2 wt % or less, or about 1 wt % or less (total weight). When the syngas generator (100) is operated under non-slagging conditions, the ash will typically be removed as a solid. When the syngas generator (100) is operated under slagging conditions, the ash will typically be removed as a liquid (molten ash), or a liquid/solid mixture.

Syngas generators potentially suitable for use in conjunction with the present invention are, in a general sense, known to those of ordinary skill in the relevant art and include, for example, those based on technologies available from Royal Dutch Shell plc, ConocoPhillips Company, Siemens AG, Lurgi AG (Sasol), General Electric Company and others. Other potentially suitable syngas generators are disclosed, for example, in US2009/0018222A1, US2007/0205092A1 and U.S. Pat. No. 6,863,878.

Gas partial oxidation (POx) syngas generators and autothermal reformers are also potentially suitable for use in conjunction with the present invention and are, in a general sense, known to those of ordinary skill in the relevant art. They include, for example, those based on technologies available from Royal Dutch Shell plc, Siemens AG, General Electric Company, Lurgi AG, Haldor Topsoe A/S, Uhde AG, KBR Inc. and others. Both catalytic and non-catalytic reactors are suitable for use in the present invention. In one embodiment, the syngas generator is a non-catalytic (thermal) POx reactor. In another embodiment, the synags generator is a catalytic autothermal reformer

When a gas POx reactor is utilized, the carbonaceous feedstock (14) will be a methane-rich stream such as, for example, sweetened gas stream (80), hydrogen-depleted sweetened gas stream (82), the methane enriched sweetened gas stream (97) or methane product stream (99), which streams result from different parts of the downstream gas processing of methane-enriched raw product stream (50) as discussed in more detail below.

### Hydromethanation—Hydromethanation Reactor (200)

As indicated above, the second carbonaceous feedstock (32), carbon monoxide, hydrogen, steam and optional oxygen are reacted in the hydromethanation reactor (200) in the presence of a hydromethanation catalyst (31), and under suitable pressure and temperature conditions, to form the methane-enriched raw product stream (50).

The hydromethanation reactor (200) is typically a fluidized-bed reactor. The hydromethanation reactor (200) can, for example, be a “flow down” countercurrent configuration, where the carbonaceous feedstock (32) is introduced at a higher point so that the particles flow down the fluidized bed to a char by-product collection zone, and the gases flow in an upward direction and are removed at a point above the fluidized bed. Alternatively, the hydromethanation reactor (200) can be a “flow up” co-current configuration, where the carbonaceous feedstock (32) is fed at a lower point so that the particles flow up the fluidized bed, along with the gases, to a char by-product collection zone. Typically, in a “flow up” configuration, there will also be a collection zone at the bottom of the reactor for larger particles (including char) which are not fluidized.

Step (g) occurs within the hydromethanation reactor (200).

When second oxygen-rich gas stream (22) is also fed into the hydromethanation reactor (200), a portion of the carbon content from the carbonaceous feedstock can also be consumed in an oxidation/combustion reaction, generating heat energy as well as carbon monoxide and hydrogen. The hydromethanation and oxidation/combustion reactions may occur contemporaneously. Depending on the configuration of the hydromethanation reactor (200), as discussed below, the two steps may occur within the same area in the reactor, or may predominant in one zone. For example, when the second oxygen-rich gas stream (22) is fed into an area of the hydromethanation reactor (200) where char by-product collects, such as below an active hydromethanation fluidized bed zone, the hydromethanation reaction will predominate in the hydromethanation fluidized bed zone, and a partial oxidation/combustion reaction will predominate in the char by-product collection area.

The hydromethanation reactor (200) is typically operated at moderate temperatures (i.e., the third temperature) of at least about 700° F. (about 371° C.), or of at least about 800° F. (about 427° C.), or of at least about 900° F. (about 482° C.), to about 1500° F. (about 816° C.), or to about 1400° F. (about 760° C.), or to about 1300° F. (704° C.); and a pressure (i.e., the fourth pressure) of about 250 psig (about 1825 kPa, absolute), or about 400 psig (about 2860 kPa), or about 450 psig (about 3204 kPa), or about 500 psig (about 3549 kPa), to about 800 psig (about 5617 kPa), or to about 700 psig (about 4928 kPa), or to about 600 psig (about 4238 kPa).

Typical gas flow velocities in the hydromethanation reactor (200) are from about 0.5 ft/sec (about 0.15 m/sec), or from about 1 ft/sec (about 0.3 m/sec), to about 2.0 ft/sec (about 0.6 m/sec), or to about 1.5 ft/sec (about 0.45 m/sec).

The hydromethanation reaction also has a heat demand, a steam demand and a syngas demand. These conditions in combination are important factors in determining the operating conditions for the remainder of the process.

For example, the steam demand of the hydromethanation reaction requires a molar ratio of steam to carbon in the feedstock of at least about 1. Typically, however, the molar ratio is greater than about 1, or about 2 or greater, to about 6 (or less), or to about 5 (or less), or to about 4 (or less), or to about 3 (or less).

As also indicated above, the hydromethanation reaction is essentially thermally balanced but, due to process heat losses and other energy requirements (for example, vaporization of moisture on the feedstock), some heat must be added to the hydromethanation reaction to maintain the thermal balance. The addition of the hydromethanation feed stream (30) at a temperature above the operating temperature of the hydromethanation reactor (200) can be one mechanism for supplying this extra heat.

Cooled syngas stream (24) exiting heat exchanger (170), however, will generally be at or below the operating temperature of the hydromethanation reaction (200). Cooled syngas stream (24) can, however, superheated through one or a combination of mechanisms.

For example, stream (24) can be passed through an optional superheater (171) in communication with a heat exchanger (172) which is upstream of heat exchanger (170).

As another example, superheated steam (26) can be heat exchanged with, or combined with, stream (24) in superheater (171). Advantageously, superheated steam (26) can be process steam.

Superheater (171) can also be a furnace in which, for example, a portion of the syngas raw product stream (51) is combusted for heat energy.

Another mechanism for superheating/temperature control is the capture of heat energy generated by the partial combustion/oxidation of carbon (from the carbonaceous feedstock) in the presence of the second oxygen-rich gas introduced into the hydromethanation reactor (200). The second oxygen-rich gas stream (22) can be fed into the hydromethanation reactor (200) by any suitable means such as direct injection of purified oxygen, oxygen-air mixtures, or oxygen-inert gas mixtures into the reactor bottom. Generally, the second oxygen-rich gas stream (22) can be introduced as an admixture with superheated steam (such as in combination with hydromethanation feed stream (30)), typically at a point below the fluidized bed hydromethanation) zone, in order to assist in fluidization of the fluidized bed, to avoid formation of hot spots in the reactor, and to avoid combustion of the gaseous products. The second oxygen-rich gas stream (22) can also advantageously be introduced into an area of the hydromethanation reactor (200) where by-product char is collected, typically in the bottom of the reactor, so that carbon in the by-product char is consumed as opposed to carbon in a more active hydromethanation zone.

A person of ordinary skill in the art can determine the amount of heat required to be added to the hydromethanation reactor (200) to substantially maintain thermal balance. When the in situ carbon combustion/oxidation is considered in conjunction with flow rate, composition, temperature and pressure of the hydromethanation feed stream (30), along with other process factors recognizable to those of ordinary skill in the relevant art, this will in turn dictate the temperature and pressure of the hydromethanation feed steam (30) as it enters the hydromethanation reactor (200) and, in turn, the operating temperature and pressure of the syngas generator (100) and any quenching of the first gas stream (20) that may be necessary.

The gas utilized in the hydromethanation reactor (200) for pressurization and reactions of the second carbonaceous feedstock (32) comprises the hydromethanation feed stream (30), optionally in combination with the second oxygen-rich gas stream (22) and, optionally, additional steam, nitrogen, air, or inert gases such as argon, which can be supplied to the hydromethanation reactor (200) according to methods known to those skilled in the art. As a consequence, the hydromethanation feed stream (30) must be provided at a higher pressure which allows it to enter the hydromethanation reactor (200).

When utilized, the amount of oxygen as well as the injection rates and pressures are controlled to allow for partial combustion of carbon in the second carbonaceous feedstock, partially consumed second carbonaceous feedstock and/or char residue. As mentioned above, the partial combustion of carbon from the second carbonaceous feedstock in the presence of the second oxygen-rich gas stream generates heat as well as carbon monoxide and hydrogen needed to assist in the maintenance of the thermal and syngas balance of the hydromethanation process, thus in conjunction with the hydromethanation feed stream (30) advantageously eliminating the need for recycle carbon monoxide and hydrogen gas loops, and external fired superheaters, in the process.

In this context, the variation of the amount of oxygen supplied to hydromethanation reactor (200) provides an advantageous process control. Increasing the amount of oxygen will increase the combustion, and therefore increase in situ heat generation. Decreasing the amount of oxygen will conversely decrease the in situ heat generation.

Advantageously, steam for the hydromethanation reaction is generated from other process operations through process heat capture (such as generated in a waste heat boiler, generally referred to as “process steam” or “process-generated steam”) and, in some embodiments, is solely supplied as process-generated steam. For example, process steam streams (such as (28), (40), (42) and (43)) generated by a heat exchanger unit or waste heat boiler (such as, for example, (170), (400), (402) and (403)) can be fed to the hydromethanation reactor (200).

In certain embodiments, the overall process described herein is substantially steam neutral, such that steam demand (pressure and amount) for the hydromethanation reaction can be satisfied via heat exchange with process heat at the different stages therein, or steam positive, such that excess steam is produced and can be used, for example, for power generation. Desirably, process-generated steam accounts for greater than about 95 wt %, or greater than about 97 wt %, or greater than about 99 wt %, or about 100 wt % or greater, of the steam demand of the hydromethanation reaction.

The result of the hydromethanation reaction is a methane-enriched raw product stream (50) typically comprising CH₄, CO₂, H₂, CO, H₂S, unreacted steam, entrained fines and, optionally, other contaminants such as NH₃, COS, HCN and/or elemental mercury vapor, depending on the nature of the carbonaceous material utilized for hydromethanation.

The methane-enriched raw product stream (50), upon exiting the hydromethanation reactor (200), will typically comprise at least about 20 mol % methane based on the moles of methane, carbon dioxide, carbon monoxide and hydrogen in the methane-enriched raw product stream (50). In addition, the methane-enriched raw product stream (50) will typically comprise at least about 50 mol % methane plus carbon dioxide, based on the moles of methane, carbon dioxide, carbon monoxide and hydrogen in the methane-enriched raw product stream (50).

If the hydromethanation feed gas stream (30) contains an excess of carbon monoxide and/or hydrogen above and beyond the syngas demand, then there may be some dilution effect on the molar percent of methane and carbon dioxide in the methane-enriched raw product stream.

### Further Gas Processing

### Fines Removal

The hot gas effluent leaving the reaction chamber of the hydromethanation reactor (200) can pass through a fines remover unit (not pictured), incorporated into and/or external of the hydromethanation reactor (200), which serves as a disengagement zone. Particles too heavy to be entrained by the gas leaving the hydromethanation reactor (200) (i.e., fines) are returned to the reaction chamber (e.g., fluidized bed).

Residual entrained fines may be substantially removed, when necessary, by any suitable device such as internal and/or external cyclone separators optionally followed by Venturi scrubbers. The recovered fines can be processed to recover alkali metal catalyst, or directly recycled back to feedstock preparation as described in previously incorporated US2009/0217589A1.

Removal of a “substantial portion” of fines means that an amount of fines is removed from the resulting gas stream such that downstream processing is not adversely affected; thus, at least a substantial portion of fines should be removed. Some minor level of ultrafine material may remain in the resulting gas stream to the extent that downstream processing is not significantly adversely affected. Typically, at least about 90 wt %, or at least about 95 wt %, or at least about 98 wt %, of the fines of a particle size greater than about 20 μm, or greater than about 10 μm, or greater than about 5 μm, are removed.

Combination with Syngas Raw Product Stream

Typically, at some point downstream of the hydromethanation reactor (200) and first heat exchanger unit (170), the methane-enriched raw product stream (50) and at least a portion of the syngas raw product stream (51) will be combined for further processing to ultimately generate a product stream. The combination can occur at various points along the gas processing loop.

Typical combination areas include before, in or after second heat exchanger unit (400), before trace contaminant removal unit (500), and/or subsequent to an ammonia removal and recovery operation (600), and before sour shift unit (700) if present, or otherwise before acid gas removal unit (800).

The units and other gas processing operations are discussed in further detail below. In the context of these discussions, reference to the methane-enriched raw product stream (or a stream downstream of the methane-enriched raw product stream) includes the optional combination with a portion or all of the syngas raw product stream (combined raw product stream).

### Second Heat Exchanger Unit (400)

Depending on the hydromethanation conditions, the methane-enriched raw product stream (50) exiting the hydromethanation reactor (200) can be generated having at a temperature ranging from about 800° F. (about 427° C.) to about 1500° F. (about 816° C.), and more typically from about 1100° F. (about 593° C.) to about 1400° F. (about 760° C.), a pressure of from about 50 psig (about 446 kPa) to about 800 psig (about 5617 kPa), more typically from about 400 psig (about 2860 kPa) to about 600 psig (about 4238 kPa), and a velocity of from about 0.5 ft/sec (about 0.15 m/sec) to about 2.0 ft/sec (about 0.61 m/sec), more typically from about 1.0 ft/sec (0.30 m/sec) to about 1.5 ft/sec (about 0.46 m/sec).

The methane-enriched raw product stream (50) can be, for example, provided to a heat recovery unit, e.g., second heat exchanger unit (400) as shown in FIG. 2. The heat exchanger (400) removes at least a portion of the heat energy from the methane-enriched raw product stream (50) and reduces the temperature of the methane-enriched raw product stream (50) to generate a cooled methane-enriched raw product stream (70) having a temperature less than the methane-enriched raw product stream (50). The heat energy recovered by heat exchanger (400) can be used to generate a second process steam stream (40) of which at least a portion can, for example, be recycled to the syngas generator (100), used as the aqueous quench stream (25), used as steam stream (26), or some combination of the above.

In one embodiment, second heat exchanger unit (400) has both a steam boiler section preceded by a superheating section. A stream of boiler feed water can be passed through the steam boiler section to generate a process steam stream, which is then passed through the superheating section to generate a superheated process steam stream of a suitable temperature and pressure for introduction into hydromethanation reactor (200).

The resulting cooled methane-enriched raw product stream (70) will typically exit second heat exchanger unit (400) at a temperature ranging from about 450° F. (about 232° C.) to about 1100° F. (about 593° C.), more typically from about 550° F. (about 288° C.) to about 950° F. (about 510° C.), a pressure of from about 50 psig (about 446 kPa) to about 800 psig (about 5617 kPa), more typically from about 400 psig (about 2860 kPa) to about 600 psig (about 4238 kPa), and a velocity of from about 0.5 ft/sec (about 0.15 m/sec) to about 2.0 ft/sec (about 0.61 m/sec), more typically from about 1.0 ft/sec (0.30 m/sec) to about 1.5 ft/sec (about 0.46 m/sec).

### Gas Purification

Product purification may comprise, for example, optional trace contaminant removal (500), optional ammonia removal and recovery (600), and optional sour shift processes (700), followed by acid gas removal (800). Methanation (900 and 950) can be performed before and/or after acid gas removal (800). The acid gas removal (800) may be performed on the cooled methane-enriched raw product stream (70) passed directly from second heat exchanger unit (400), or on the cooled methane-enriched raw product stream (70) that has passed through either one or more of optional (i) one or more of the trace contaminants removal units (500); (ii) one or more ammonia recovery units (600); (iii) one or more sour shift units (700); and (iv) one or more sulfur-tolerant catalytic methanation units (900).

Trace Contaminant Removal (500)

As is familiar to those skilled in the art, the contamination levels of the gas stream, e.g., cooled methane-enriched raw product stream (70), will depend on the nature of the carbonaceous material used for preparing the carbonaceous feedstocks. For example, certain coals, such as Illinois #6, can have high sulfur contents, leading to higher COS contamination; and other coals, such as Illinois #6 and Powder River Basin coals, can contain significant levels of mercury which can be volatilized in the syngas generator and/or hydromethanation reactor.

COS can be removed from a gas stream, e.g. the cooled methane-enriched raw product stream (70), by COS hydrolysis (see, U.S. Pat. No. 3,966,875, U.S. Pat. No. 4,011,066, U.S. Pat. No. 4,100,256, U.S. Pat. No. 4,482,529 and U.S. Pat. No. 4,524,050), passing the gas stream through particulate limestone (see, U.S. Pat. No. 4,173,465), an acidic buffered CuSO₄ solution (see, U.S. Pat. No. 4,298,584), an alkanolamine absorbent such as methyldiethanolamine, triethanolamine, dipropanolamine or diisopropanolamine, containing tetramethylene sulfone (sulfolane, see, U.S. Pat. No. 3,989,811); or counter-current washing of the cooled second gas stream with refrigerated liquid CO₂ (see, U.S. Pat. No. 4,270,937 and U.S. Pat. No. 4,609,388).

HCN can be removed from a gas stream, e.g., the cooled methane-enriched raw product stream (70), by reaction with ammonium sulfide or polysulfide to generate CO₂, H₂S and NH₃ (see, U.S. Pat. No. 4,497,784, U.S. Pat. No. 4,505,881 and U.S. Pat. No. 4,508,693), or a two stage wash with formaldehyde followed by ammonium or sodium polysulfide (see, U.S. Pat. No. 4,572,826), absorbed by water (see, U.S. Pat. No. 4,189,307), and/or decomposed by passing through alumina supported hydrolysis catalysts such as MoO₃, TiO₂ and/or ZrO₂ (see, U.S. Pat. No. 4,810,475, U.S. Pat. No. 5,660,807 and U.S. Pat. No. 5,968,465).

Elemental mercury can be removed from a gas stream, e.g., the cooled methane-enriched raw product stream (70), for example, by absorption by carbon activated with sulfuric acid (see, U.S. Pat. No. 3,876,393), absorption by carbon impregnated with sulfur (see, U.S. Pat. No. 4,491,609), absorption by a H₂S-containing amine solvent (see, U.S. Pat. No. 4,044,098), absorption by silver or gold impregnated zeolites (see, U.S. Pat. No. 4,892,567), oxidation to HgO with hydrogen peroxide and methanol (see, U.S. Pat. No. 5,670,122), oxidation with bromine or iodine containing compounds in the presence of SO₂ (see, U.S. Pat. No. 6,878,358), oxidation with a H, Cl and O— containing plasma (see, U.S. Pat. No. 6,969,494), and/or oxidation by a chlorine-containing oxidizing gas (e.g., ClO, see, U.S. Pat. No. 7,118,720).

When aqueous solutions are utilized for removal of any or all of COS, HCN and/or Hg, the waste water generated in the trace contaminants removal units can be directed to a waste water treatment unit (not depicted).

When present, a trace contaminant removal of a particular trace contaminant should remove at least a substantial portion (or substantially all) of that trace contaminant from the so-treated gas stream (e.g., cooled methane-enriched raw product stream (70)), typically to levels at or lower than the specification limits of the desired product stream. Typically, a trace contaminant removal should remove at least 90%, or at least 95%, or at least 98%, of COS, HCN and/or mercury from a cooled first gas stream.

Ammonia Removal and Recovery (600)

As is familiar to those skilled in the art, gasification of biomass, certain coals and/or utilizing air as an oxygen source for the catalytic gasifier can produce significant quantities of ammonia in the product stream. Optionally, a gas stream, e.g. the cooled methane-enriched raw product stream (70), can be scrubbed by water in one or more ammonia removal and recovery units (600) to remove and recover ammonia. The ammonia recovery treatment may be performed, for example, on the cooled methane-enriched raw product stream (70), directly from second heat exchanger unit (400) or after treatment in one or both of optional (i) one or more of the trace contaminants removal units (500), and (ii) one or more sour shift units (700).

After scrubbing, the gas stream, e.g., the cooled methane-enriched raw product stream (70), will typically comprise at least H₂S, CO₂, CO, H₂ and CH₄. When the cooled methane-enriched raw product stream (70) has previously passed through a sour shift unit (700), then, after scrubbing, the gas stream will typically comprise at least H₂S, CO₂, H₂ and CH₄.

Ammonia can be recovered from the scrubber water according to methods known to those skilled in the art, can typically be recovered as an aqueous solution (61) (e.g., 20 wt %). The waste scrubber water can be forwarded to a waste water treatment unit (not depicted).

When present, an ammonia removal process should remove at least a substantial portion (and substantially all) of the ammonia from the scrubbed stream, e.g., the cooled methane-enriched raw product stream (70). “Substantial” removal in the context of ammonia removal means removal of a high enough percentage of the component such that a desired end product can be generated. Typically, an ammonia removal process will remove at least about 95%, or at least about 97%, of the ammonia content of a scrubbed first gas stream.

Sour Shift (700)

A portion or all of the methane-enriched raw product stream (e.g., cooled methane-enriched raw product stream (70)) can be optionally supplied to a sour shift reactor (700) to undergo a sour shift reaction (also known as a water-gas shift reaction) in the presence of an aqueous medium (such as steam) to convert a portion of the CO to CO₂ and to increase the fraction of H₂ in order to produce a hydrogen-enriched raw product stream (72). In certain examples, the generation of increased hydrogen content can be utilized to form a hydrogen product gas stream (85) which can be separated from a sweetened gas stream (80) as discussed below. In certain other examples, a sour shift process may be used to adjust the hydrogen:carbon monoxide ratio in a gas stream, e.g., the cooled methane-enriched raw product stream (70), for providing to a subsequent methanator, which is particularly useful when such molar ratio is less than about 3:1. The water-gas shift treatment may be performed on the cooled methane-enriched raw product stream (70) passed directly from second heat exchanger unit (400), or on the cooled methane-enriched raw product stream (70) that has passed through an optional trace contaminants removal unit (500) and/or an ammonia removal unit (600).

A sour shift process is described in detail, for example, in U.S. Pat. No. 7,074,373. The process involves adding water, or using water contained in the gas, and reacting the resulting water-gas mixture adiabatically over a steam reforming catalyst. Typical steam reforming catalysts include one or more Group VIII metals on a heat-resistant support.

Methods and reactors for performing the sour gas shift reaction on a CO-containing gas stream are well known to those of skill in the art. Suitable reaction conditions and suitable reactors can vary depending on the amount of CO that must be depleted from the gas stream. In some embodiments, the sour gas shift can be performed in a single stage within a temperature range from about 100° C., or from about 150° C., or from about 200° C., to about 250° C., or to about 300° C., or to about 350° C. In these embodiments, the shift reaction can be catalyzed by any suitable catalyst known to those of skill in the art. Such catalysts include, but are not limited to, Fe₂O₃-based catalysts, such as Fe₂O₃—Cr₂O₃ catalysts, and other transition metal-based and transition metal oxide-based catalysts. In other embodiments, the sour gas shift can be performed in multiple stages. In one particular embodiment, the sour gas shift is performed in two stages. This two-stage process uses a high-temperature sequence followed by a low-temperature sequence. The gas temperature for the high-temperature shift reaction ranges from about 350° C. to about 1050° C. Typical high-temperature catalysts include, but are not limited to, iron oxide optionally combined with lesser amounts of chromium oxide. The gas temperature for the low-temperature shift ranges from about 150° C. to about 300° C., or from about 200° C. to about 250° C. Low-temperature shift catalysts include, but are not limited to, copper oxides that may be supported on zinc oxide or alumina. Suitable methods for the sour shift process are described in previously incorporated US2009/0246120A1.

In some embodiments, it will be desirable to remove a substantial portion of the CO from the cooled methane-enriched raw product stream (70), and thus convert a substantial portion of the CO. “Substantial” conversion in this context means conversion of a high enough percentage of the component such that a desired end product can be generated. Typically, streams exiting the shift reactor, where a substantial portion of the CO has been converted, will have a carbon monoxide content of about 250 ppm or less CO, and more typically about 100 ppm or less CO.

In other embodiments, it will be desirable to convert only a portion of the CO so as to increase the fraction of H₂ for a subsequent methanation, e.g., a trim methanation, which will typically require an H₂/CO molar ratio of about 3 or greater, or greater than about 3, or about 3.2 or greater.

Following the sour gas shift procedure, the cooled methane-enriched raw product stream (70) generally contains CH₄, CO₂, H₂, H₂S and steam, and typically some CO as well (for downstream methanation).

The sour shift reaction is exothermic, so it is often carried out with a heat exchanger, such as third heat exchanger unit (401), to permit the efficient use of heat energy. Shift reactors employing these features are well known to those of skill in the art. An example of a suitable shift reactor is illustrated in previously incorporated U.S. Pat. No. 7,074,373, although other designs known to those of skill in the art are also effective.

While third heat exchanger unit (401) is depicted as a separate unit, it can exist as such and/or be integrated into the sour shift reactor (700), thus being capable of cooling the sour shift reactor (700) and removing at least a portion of the heat energy from the hydrogen-enriched raw product stream (72), if present, to reduce the temperature of the hydrogen-enriched raw product stream (72), if present, to generate a cooled hydrogen-enriched raw product stream. At least a portion of the recovered heat energy can be used to generate a process steam stream from a water/steam source.

In an alternative embodiment, the hydrogen-enriched raw product stream (72), upon exiting sour shift reactor (700), is introduced into a superheater followed by a boiler feed water preheater. The superheater can be used, for example, to superheat a stream which can be a portion of cooled methane-enriched raw product stream (70), to generate a superheated stream which is then recombined into cooled methane-enriched raw product stream (70). Alternatively, all of cooled methane-enriched product stream can be preheated in the superheater and subsequently fed into sour shift reactor (700) as superheated stream.

In one embodiment, the third heat exchanger unit (401) comprises a boiler feed water preheater which can be used, for example, to preheat boiler feed water (39) and generate a pre-heated boiler feed water stream (41) for one or more of first heat exchanger unit (170), second heat exchanger unit (400), fourth heat exchanger unit (402) and fifth heat exchanger unit (403), as well as other steam generation operations.

If it is desired to retain some of the carbon monoxide content of the methane-enriched raw product stream (50), a gas bypass loop (70a) in communication with the first heat recovery unit (400) can be provided to allow some or all of the cooled methane-enriched raw product stream (70) exiting the first heat recovery unit (400) to bypass the sour shift reactor (700) and the second heat recovery unit (e.g., heat exchanger (401)) altogether and enter the acid gas removal unit (800). This is particularly useful when it is desired to recover a separate methane product stream, as the retained carbon monoxide can be subsequently methanated as discussed below.

Acid Gas Removal (800)

A subsequent acid gas removal unit (800) can be used to remove a substantial portion of H₂S and CO₂ from the methane-enriched raw product stream, e.g., cooled methane-enriched raw product stream (70), and generate a sweetened gas stream (80).

Acid gas removal processes typically involve contacting a gas stream with a solvent such as monoethanolamine, diethanolamine, methyldiethanolamine, diisopropylamine, diglycolamine, a solution of sodium salts of amino acids, methanol, hot potassium carbonate or the like to generate CO₂ and/or H₂S laden absorbers. One method can involve the use of Selexol® (UOP LLC, Des Plaines, Ill. USA) or Rectisol® (Lurgi AG, Frankfurt am Main, Germany) solvent having two trains; each train containing an H₂S absorber and a CO₂ absorber.

One method for removing acid gases is described in previously incorporated US2009/0220406A1.

At least a substantial portion (e.g., substantially all) of the CO₂ and/or H₂S (and other remaining trace contaminants) should be removed via the acid gas removal processes. “Substantial” removal in the context of acid gas removal means removal of a high enough percentage of the component such that a desired end product can be generated. The actual amounts of removal may thus vary from component to component. For “pipeline-quality natural gas”, only trace amounts (at most) of H₂S can be present, although higher amounts of CO₂ may be tolerable.

Typically, at least about 85%, or at least about 90%, or at least about 92%, of the CO₂, and at least about 95%, or at least about 98%, or at least about 99.5%, of the H₂S, should be removed from the cooled methane-enriched raw product stream (70).

Losses of desired product (methane) in the acid gas removal step should be minimized such that the sweetened gas stream (80) comprises at least a substantial portion (and substantially all) of the methane from the second gas stream (e.g., cooled methane-enriched raw product stream (70)). Typically, such losses should be about 2 mol % or less, or about 1.5 mol % or less, or about 1 mol % of less, of the methane from the cooled methane-enriched raw product stream (70).

The resulting sweetened gas stream (80) will generally comprise CH₄ and H₂, typically some CO (especially where downstream methanation is performed), and typically no more than contaminant amounts of CO₂ and H₂O.

Any recovered H₂S (78) from the acid gas removal (and other processes such as sour water stripping) can be converted to elemental sulfur by any method known to those skilled in the art, including the Claus process. Sulfur can be recovered as a molten liquid.

Any recovered CO₂ (79) from the acid gas removal can be compressed for transport in CO₂ pipelines, industrial use, and/or sequestration for storage or other processes such as enhanced oil recovery.

Prior to acid gas removal unit (800), the cooled methane-enriched raw product stream (70) can be treated to reduced water content in via a knock-out drum or similar water separation device (450). A resulting sour waste water stream (47) can be sent to a wastewater treatment unit (not depicted) for further processing.

Hydrogen Separation (850)

Hydrogen may optionally be separated from the sweetened product gas stream (80) according to methods known to those skilled in the art, such as cryogenic distillation, the use of molecular sieves, gas separation (e.g., ceramic and/or polymer) membranes, and/or pressure swing adsorption (PSA) techniques. See, for example, previously incorporated US2009/0259080A1.

In one embodiment, a PSA device is utilized for hydrogen separation. PSA technology for separation of hydrogen from gas mixtures containing methane (and optionally carbon monoxide) is in general well-known to those of ordinary skill in the relevant art as disclosed, for example, in U.S. Pat. No. 6,379,645 (and other citations referenced therein). PSA devices are generally commercially available, for example, based on technologies available from Air Products and Chemicals Inc. (Allentown, Pa.), UOP LLC (Des Plaines, Ill.) and others.

In another embodiment, a hydrogen membrane separator can be used followed by a PSA device.

Such separation provides a high-purity hydrogen product stream (85) and a hydrogen-depleted sweetened gas stream (82).

The recovered hydrogen product stream (85) preferably has a purity of at least about 99 mole %, or at least 99.5 mole %, or at least about 99.9 mole %.

The hydrogen product stream (85) can be used, for example, as an energy source and/or as a reactant. For example, the hydrogen can be used as an energy source for hydrogen-based fuel cells, for power and/or steam generation (see 980, 982 and 984 in FIG. 2), and/or for a subsequent hydromethanation process. The hydrogen can also be used as a reactant in various hydrogenation processes, such as found in the chemical and petroleum refining industries.

The hydrogen-depleted sweetened gas stream (82) will comprise substantially methane, with optional minor amounts of carbon monoxide (depending primarily on the extent of the sour shift reaction and bypass), carbon dioxide (depending primarily on the effectiveness of the acid gas removal process) and hydrogen (depending primarily on the extent and effectiveness of the hydrogen separation technology).

Methanation (900 and 950)

The gasification processes described herein can utilize at least one methanation step to generate methane from the carbon monoxide and hydrogen present in one or more of the gas streams before (e.g., cooled methane-enriched raw product stream (70)) and/or after (e.g., sweetened gas stream (80)) acid gas removal unit (800).

The methanation reaction can be carried out in any suitable reactor, e.g., a single-stage methanation reactor, a series of single-stage methanation reactors or a multistage reactor. Methanator reactors include, without limitation, fixed bed, moving bed or fluidized bed reactors. See, for instance, U.S. Pat. No. 3,958,957, U.S. Pat. No. 4,252,771, U.S. Pat. No. 3,996,014 and U.S. Pat. No. 4,235,044. The catalyst used in the methanation, and methanation conditions, will depend on the temperature, pressure and composition of the incoming gas stream.

For example, in one embodiment of the invention, at least a portion of the carbon monoxide and at least a portion of the hydrogen present in the cooled methane-enriched raw product stream (70) is reacted in a first catalytic methanator (900) in the presence of a sulfur-tolerant methanation catalyst to produce a methane-enriched first gas stream (92), which can then be subjected to acid gas removal as described above. At this stage, the cooled methane-enriched raw product stream (70) typically contains significant quantities of hydrogen sulfide which can deactivate certain methanation catalysts as is familiar to those skilled in the art. Therefore, in such embodiments, the catalytic methanator (900) comprises a sulfur-tolerant methanation catalyst such as molybdenum and/or tungsten sulfides. Further examples of sulfur-tolerant methanation catalysts include, but are not limited to, catalysts disclosed in U.S. Pat. No. 4,243,554, U.S. Pat. No. 4,243,553, U.S. Pat. No. 4,006,177, U.S. Pat. No. 3,958,957, U.S. Pat. No. 3,928,000 and US2490488; Mills and Steffgen, in Catalyst Rev. 8, 159 (1973)); and Schultz et al, U.S. Bureau of Mines, Rep. Invest. No. 6974 (1967).

In one particular example, the sulfur-tolerant methanation catalyst is a portion of the char by-product (54) generated by the hydromethanation reactor (200) which can be periodically removed from the hydromethanation reactor (200) and transferred to the first catalytic methanator (900), as is described in previously incorporated US2010/0121125A1. Operating conditions for a methanator utilizing the char can be similar to those set forth in previously incorporated U.S. Pat. No. 3,958,957. When one or more methanation steps are included in an integrated gasification process that employs at least a portion of the char product as the sulfur-tolerant methanation catalyst, the methanation temperatures generally range from about 450° C., or from about 475° C., or from about 500° C., to about 650° C., or to about 625° C., or to about 600° C. and at a pressure from about 400 to about 750 psig.

In other embodiments of the invention, if the sweetened gas stream (80) comprises hydrogen and greater than above 100 ppm carbon monoxide, carbon monoxide and hydrogen present in the sweetened gas stream (80) can be reacted in a second catalytic methanator (950) in the presence of a methanation catalyst to produce a methane-enriched gas stream (97).

In certain embodiments of the invention, both of these methanation steps are performed.

As the methanation reaction is exothermic, in various embodiments the methane-enriched gas streams (92) and (97) may be, for example, further provided to a heat recovery unit, e.g., fourth and fifth heat exchanger units (402) and (403). While the heat exchanger units (402) and (403) are depicted as separate units, they can exist as such and/or be integrated into the methanators (900) and (950), thus being capable of cooling the methanator units and removing at least a portion of the heat energy from the methane-enriched gas streams to reduce the temperature of the methane-enriched gas streams. The recovered heat energy can be utilized to generate process steam streams (42) and (43) from a water and/or steam source (41b and 41c).

Methane Separation (970)

In various embodiments, the sweetened gas stream (80), or the hydrogen-depleted gas stream (82), or the methane-enriched gas stream (97) is the methane product stream (99). In various other embodiments, these streams can be further purified (970) to generate the methane product stream.

The gas streams can be processed, when necessary, to separate and recover CH₄ by any suitable gas separation method known to those skilled in the art including, but not limited to, cryogenic distillation and the use of molecular sieves or gas separation (e.g., ceramic and/or polymer) membranes. For example, when a sour shift process is present, the second gas stream may contain methane and hydrogen which can be separated according to methods familiar to those skilled in the art, such as cryogenic distillation.

Gas purification methods include, for example, the generation of methane hydrate as disclosed in previously incorporated US2009/0260287A1, US2009/0259080A1 and US2009/0246120A1.

As indicated previously, when syngas generator (100) is a gas-based POx or authoermal reformer reactor, all or a portion of the sweetened gas stream (80), the hydrogen-depleted gas stream (82), the methane-enriched gas stream (97) or the methane product stream (99) can be used as the gas first carbonaceous feedstock (14), depending on desired end product and overall process/system configuration.

Pipeline-Quality Natural Gas

The invention provides processes and systems that, in certain embodiments, are capable of generating “pipeline-quality natural gas” from the hydromethanation of carbonaceous materials. A “pipeline-quality natural gas” typically refers to a natural gas that is (1) within ±5% of the heating value of pure methane (whose heating value is 1010 btu/ft³ under standard atmospheric conditions), (2) substantially free of water (typically a dew point of about −40° C. or less), and (3) substantially free of toxic or corrosive contaminants. In some embodiments of the invention, the methane product stream (99) described in the above processes satisfies such requirements.

### Waste Water Treatment

Residual contaminants in waste water resulting from any one or more of the trace contaminant removal, sour shift, ammonia removal, acid gas removal and/or catalyst recovery processes can be removed in a waste water treatment unit to allow recycling of the recovered water within the plant and/or disposal of the water from the plant process according to any methods known to those skilled in the art. Depending on the feedstock and reaction conditions, such residual contaminants can comprise, for example, phenols, CO, CO₂, H₂S, COS, HCN, ammonia, and mercury. For example, H₂S and HCN can be removed by acidification of the waste water to a pH of about 3, treating the acidic waste water with an inert gas in a stripping column, and increasing the pH to about 10 and treating the waste water a second time with an inert gas to remove ammonia (see U.S. Pat. No. 5,236,557). H₂S can be removed by treating the waste water with an oxidant in the presence of residual coke particles to convert the H₂S to insoluble sulfates which may be removed by flotation or filtration (see U.S. Pat. No. 4,478,425). Phenols can be removed by contacting the waste water with a carbonaceous char containing mono- and divalent basic inorganic compounds (e.g., the solid char product or the depleted char after catalyst recovery, supra) and adjusting the pH (see U.S. Pat. No. 4,113,615). Phenols can also be removed by extraction with an organic solvent followed by treatment of the waste water in a stripping column (see U.S. Pat. No. 3,972,693, U.S. Pat. No. 4,025,423 and U.S. Pat. No. 4,162,902).

### Process Steam

A steam feed loop can be provided for feeding the various process steam streams (e.g., 28, 40, 42 and 43) generated from heat energy recovery.

The process steam streams can be generated by contacting a water/steam source (such as (25), (41a), (41b) and (41c)) with the heat energy recovered from the various process operations using one or more heat recovery units, such as heat exchangers (170), (400), (402) and (403). Also, for example, when slurried carbonaceous materials are dried with a fluid bed slurry drier, as discussed below for the preparation of the catalyzed second carbonaceous feedstock (31+32), the steam generated through vaporization can be used as process steam.

Any suitable heat recovery unit known in the art may be used. For example, a steam boiler or any other suitable steam generator (such as a shell/tube heat exchanger) that can utilize the recovered heat energy to generate steam can be used. The heat exchangers may also function as superheaters for steam streams, so that heat recovery through one of more stages of the process can be used to superheat the steam to a desired temperature and pressure, thus eliminating the need for separate fired superheaters.

While any water source can be used to generate steam, the water commonly used in known boiler systems is purified and deionized (about 0.3-1.0 μS/cm) so that corrosive processes are slowed.

In the context of the present process, the hydromethanation reaction will have a steam demand (temperature, pressure and volume), and the amount of process steam and process heat recovery can be sufficient to provide at least about 85 wt %, or at least about 90 wt %, or at least about 94 wt %, or at least about 97 wt %, or at least about 98 wt %, or at least about 99 wt %, of this total steam demand. The remaining about 15 wt % or less, or about 10 wt % or less, or about 6 wt % or less, or about 3 wt % or less, or about 2 wt % or less, or about 1 wt % or less, can be supplied by a make-up steam stream, which can be fed into the system as (or as a part of) steam stream (25).

A suitable steam boiler or steam generator can be used to provide any needed make-up steam. Such boilers can be powered, for example, through the use of any carbonaceous material such as powdered coal, biomass etc., and including but not limited to rejected carbonaceous materials from the feedstock preparation operations (e.g., fines, supra). Steam can also be supplied from an additional catalytic gasifier coupled to a combustion turbine where the exhaust from the reactor is thermally exchanged to a water source and produce steam. Alternatively, the steam may be generated for the catalytic gasifiers as described in previously incorporated US2009/0165376A1, US2009/0217584A1 and US2009/0217585A1.

In another embodiment, the process steam stream or streams supply substantially all of the total steam demand for the hydromethanation reaction, in which there is substantially no make-up steam stream.

In another embodiment, an excess of process steam is generated. The excess steam can be used, for example, for power generation via a steam turbine, and/or drying the carbonaceous feedstock in a fluid bed drier to a desired reduced moisture content, as discussed below.

### Power Generation

All or a portion of the sweetened gas stream (80), the hydrogen-depleted gas stream (82), the methane-enriched gas stream (97) or the methane product stream (99) can be utilized for combustion (980) and steam generation (982), as can all or a portion of the recovered hydrogen (85). Steam generated by a steam generator (982) may be utilized within the preceding processes or provided to one or more power generators (984), such as a combustion or steam turbine, to produce electricity which may be either utilized within the plant or can be sold onto the power grid.

### Preparation of Carbonaceous Feedstocks

Carbonaceous Materials Processing (90)

Carbonaceous materials, such as biomass and non-biomass (supra), can be prepared via crushing and/or grinding, either separately or together, according to any methods known in the art, such as impact crushing and wet or dry grinding to yield one or more carbonaceous particulates. Depending on the method utilized for crushing and/or grinding of the carbonaceous material sources, the resulting carbonaceous particulates may be sized (i.e., separated according to size) to provide the first carbonaceous feedstock (12) for use in the syngas generator (100), and/or for use in catalyst loading processes (350) to form a catalyzed second carbonaceous feedstock (31+32) for the hydromethanation reactor (200).

Any method known to those skilled in the art can be used to size the particulates. For example, sizing can be performed by screening or passing the particulates through a screen or number of screens. Screening equipment can include grizzlies, bar screens, and wire mesh screens. Screens can be static or incorporate mechanisms to shake or vibrate the screen. Alternatively, classification can be used to separate the carbonaceous particulates. Classification equipment can include ore sorters, gas cyclones, hydrocyclones, rake classifiers, rotating trommels or fluidized classifiers. The carbonaceous materials can be also sized or classified prior to grinding and/or crushing.

The carbonaceous particulate can be supplied as a fine particulate having an average particle size of from about 25 microns, or from about 45 microns, up to about 2500 microns, or up to about 500 microns. One skilled in the art can readily determine the appropriate particle size for the carbonaceous particulates. For example, when a fluidized bed reactor is used, such carbonaceous particulates can have an average particle size which enables incipient fluidization of the carbonaceous materials at the gas velocity used in the fluidized bed reactor. The particle size profile may be different for the syngas generator (100) and the hydromethanation reactor (200).

Additionally, certain carbonaceous materials, for example, corn stover and switchgrass, and industrial wastes, such as saw dust, either may not be amenable to crushing or grinding operations, or may not be suitable for use as such, for example due to ultra fine particle sizes. Such materials may be formed into pellets or briquettes of a suitable size for crushing or for direct use in, for example, a fluidized bed reactor. Generally, pellets can be prepared by compaction of one or more carbonaceous material; see for example, previously incorporated US2009/0218424A1. In other examples, a biomass material and a coal can be formed into briquettes as described in U.S. Pat. No. 4,249,471, U.S. Pat. No. 4,152,119 and U.S. Pat. No. 4,225,457. Such pellets or briquettes can be used interchangeably with the preceding carbonaceous particulates in the following discussions.

Additional feedstock processing steps may be necessary depending on the qualities of carbonaceous material sources. Biomass may contain high moisture contents, such as green plants and grasses, and may require drying prior to crushing. Municipal wastes and sewages also may contain high moisture contents which may be reduced, for example, by use of a press or roll mill (e.g., U.S. Pat. No. 4,436,028). Likewise, non-biomass, such as high-moisture coal, can require drying prior to crushing. Some caking coals can require partial oxidation to simplify operation. Non-biomass feedstocks deficient in ion-exchange sites, such as anthracites or petroleum cokes, can be pre-treated to create additional ion-exchange sites to facilitate catalyst loading and/or association. Such pre-treatments can be accomplished by any method known to the art that creates ion-exchange capable sites and/or enhances the porosity of the feedstock (see, for example, previously incorporated U.S. Pat. No. 4,468,231 and GB1599932). Oxidative pre-treatment can be accomplished using any oxidant known to the art.

The ratio and types of the carbonaceous materials in the carbonaceous particulates can be selected based on technical considerations, processing economics, availability, and proximity of the non-biomass and biomass sources. The availability and proximity of the sources for the carbonaceous materials can affect the price of the feeds, and thus the overall production costs of the catalytic gasification process. For example, the biomass and the non-biomass materials can be blended in at about 5:95, about 10:90, about 15:85, about 20:80, about 25:75, about 30:70, about 35:65, about 40:60, about 45:55, about 50:50, about 55:45, about 60:40, about 65:35, about 70:20, about 75:25, about 80:20, about 85:15, about 90:10, or about 95:5 by weight on a wet or dry basis, depending on the processing conditions.

Significantly, the carbonaceous material sources, as well as the ratio of the individual components of the carbonaceous particulates, for example, a biomass particulate and a non-biomass particulate, can be used to control other material characteristics of the carbonaceous particulates. Non-biomass materials, such as coals, and certain biomass materials, such as rice hulls, typically include significant quantities of inorganic matter including calcium, alumina and silica which form inorganic oxides (i.e., ash) in the catalytic gasifier. At temperatures above about 500° C. to about 600° C., potassium and other alkali metals can react with the alumina and silica in ash to form insoluble alkali aluminosilicates. In this form, the alkali metal is substantially water-insoluble and inactive as a catalyst. To prevent buildup of the residue in the hydromethanation reactor (200), a solid purge of char (52) comprising ash, unreacted carbonaceous material, and various other compounds (such as alkali metal compounds, both water soluble and water insoluble) can be routinely withdrawn.

In preparing the carbonaceous particulates, particularly when considering the hydromethanation reaction, the ash content of the various carbonaceous materials can be selected to be, for example, about 20 wt % or less, or about 15 wt % or less, or about 10 wt % or less, or about 5 wt % or less, depending on, for example, the ratio of the various carbonaceous materials and/or the starting ash in the various carbonaceous materials. In other embodiments, the resulting the carbonaceous particulates can comprise an ash content ranging from about 5 wt %, or from about 10 wt %, to about 20 wt %, or to about 15 wt %, based on the weight of the carbonaceous particulate. In other embodiments, the ash content of the carbonaceous particulate can comprise less than about 20 wt %, or less than about 15 wt %, or less than about 10 wt %, or less than about 8 wt %, or less than about 6 wt % alumina, based on the weight of the ash. In certain embodiments, the carbonaceous particulates can comprise an ash content of less than about 20 wt %, based on the weight of processed feedstock where the ash content of the carbonaceous particulate comprises less than about 20 wt % alumina, or less than about 15 wt % alumina, based on the weight of the ash.

Such lower alumina values in the carbonaceous particulates allow for, ultimately, decreased losses of catalysts, and particularly alkali metal catalysts, in the hydromethanation portion of the process. As indicated above, alumina can react with alkali source to yield an insoluble char comprising, for example, an alkali aluminate or aluminosilicate. Such insoluble char can lead to decreased catalyst recovery (i.e., increased catalyst loss), and thus, require additional costs of make-up catalyst in the overall process.

Additionally, the resulting carbonaceous particulates can have a significantly higher % carbon, and thus btu/lb value and methane product per unit weight of the carbonaceous particulate. In certain embodiments, the resulting carbonaceous particulates can have a carbon content ranging from about 75 wt %, or from about 80 wt %, or from about 85 wt %, or from about 90 wt %, up to about 95 wt %, based on the combined weight of the non-biomass and biomass.

In one example, a non-biomass and/or biomass is wet ground and sized (e.g., to a particle size distribution of from about 25 to about 2500 μm) and then drained of its free water (i.e., dewatered) to a wet cake consistency. Examples of suitable methods for the wet grinding, sizing, and dewatering are known to those skilled in the art; for example, see previously incorporated US2009/0048476A1. The filter cakes of the non-biomass and/or biomass particulates formed by the wet grinding in accordance with one embodiment of the present disclosure can have a moisture content ranging from about 40% to about 60%, or from about 40% to about 55%, or below 50%. It will be appreciated by one of ordinary skill in the art that the moisture content of dewatered wet ground carbonaceous materials depends on the particular type of carbonaceous materials, the particle size distribution, and the particular dewatering equipment used. Such filter cakes can be thermally treated, as described herein, to produce one or more reduced moisture carbonaceous particulates.

Each of the one or more carbonaceous particulates can have a unique composition, as described above. For example, two carbonaceous particulates can be utilized, where a first carbonaceous particulate comprises one or more biomass materials and the second carbonaceous particulate comprises one or more non-biomass materials. Alternatively, a single carbonaceous particulate comprising one or more carbonaceous materials utilized.

When an aqueous slurry is utilized as the first carbonaceous feedstock (12) (such as, for example, disclosed in previously incorporated US2009/0169448A1, the slurry can contain a ratio of carbonaceous material to water, by weight, which ranges from about 5:95 to about 60:40; for example, the ratio can be about 5:95, or about 10:90, or about 15:85, or about 20:80, or about 25:75, or about 30:70, or about 35:65, or about 40:60, or about 50:50, or about 60:40, or any other value inbetween. Any of carbonaceous materials can be used alone or in combination and slurried with water (as necessary) to produce the aqueous slurry with a predetermined carbon and water content.

The aqueous medium for preparing the aqueous slurry can either be produced from a clean water feed (e.g., a municipal water supply) and/or recycle processes. For example, reclaimed water from a sour water stripping operation and/or catalytic feedstock drying operations can be directed for preparation of the aqueous slurry. In one embodiment, the water is not clean but instead contains organic matter, such as untreated wastewater from farming, coal mining, municipal waste treatment facilities or like sources. The organic matter in the wastewater becomes part of the carbonaceous material as indicated below.

Typically, the hydromethanation reactor (200) is more sensitive to feedstock preparation then the syngas generator (100). Desirable particle size ranges for the hydromethanation reactor (200) are in the Geldart A and Geldart B ranges (including overlap between the two), depending on fluidization conditions, typically with limited amounts of fine (below about 25 microns) and coarse (greater than about 250 microns) material. Desirably, the syngas generator (100) should be capable of processing those portions of the feedstock not utilized in the hydromethanation reactor (200).

Catalyst Loading for Hydromethanation (350)

The hydromethanation catalyst is potentially active for catalyzing at least reactions (I), (II) and (III) described above. Such catalysts are in a general sense well known to those of ordinary skill in the relevant art and may include, for example, alkali metals, alkaline earth metals and transition metals, and compounds and complexes thereof. Typically, the hydromethanation catalyst is an alkali metal, such as disclosed in many of the previously incorporated references.

For the hydromethanation reaction, the one or more carbonaceous particulates are typically further processed to associate at least one hydromethanation catalyst, typically comprising a source of at least one alkali metal, to generate a catalyzed second carbonaceous feedstock (31+32).

The second carbonaceous particulate (32) provided for catalyst loading can be either treated to form a catalyzed second carbonaceous feedstock (31+32) which is passed to the hydromethanation reactor (200), or split into one or more processing streams, where at least one of the processing streams is associated with a hydromethanation catalyst to form at least one catalyst-treated feedstock stream. The remaining processing streams can be, for example, treated to associate a second component therewith. Additionally, the catalyst-treated feedstock stream can be treated a second time to associate a second component therewith. The second component can be, for example, a second hydromethanation catalyst, a co-catalyst, or other additive.

In one example, the primary hydromethanation catalyst can be provided to the single carbonaceous particulate (e.g., a potassium and/or sodium source), followed by a separate treatment to provide one or more co-catalysts and additives (e.g., a calcium source) to the same single carbonaceous particulate to yield the catalyzed second carbonaceous feedstock (31+32). For example, see previously incorporated US2009/0217590A1 and US2009/0217586A1. The hydromethanation catalyst and second component can also be provided as a mixture in a single treatment to the single carbonaceous particulate to yield the catalyzed second carbonaceous feedstock (31+32).

When one or more carbonaceous particulates are provided for catalyst loading, then at least one of the carbonaceous particulates is associated with a hydromethanation catalyst to form at least one catalyst-treated feedstock stream. Further, any of the carbonaceous particulates can be split into one or more processing streams as detailed above for association of a second or further component therewith. The resulting streams can be blended in any combination to provide the catalyzed second carbonaceous feedstock (31+32), provided at least one catalyst-treated feedstock stream is utilized to form the catalyzed feedstock stream.

In one embodiment, at least one carbonaceous particulate is associated with a hydromethanation catalyst and optionally, a second component. In another embodiment, each carbonaceous particulate is associated with a hydromethanation catalyst and optionally, a second component.

Any methods known to those skilled in the art can be used to associate one or more hydromethanation catalysts with any of the carbonaceous particulates and/or processing streams. Such methods include but are not limited to, admixing with a solid catalyst source and impregnating the catalyst onto the processed carbonaceous material. Several impregnation methods known to those skilled in the art can be employed to incorporate the hydromethanation catalysts. These methods include but are not limited to, incipient wetness impregnation, evaporative impregnation, vacuum impregnation, dip impregnation, ion exchanging, and combinations of these methods.

In one embodiment, an alkali metal hydromethanation catalyst can be impregnated into one or more of the carbonaceous particulates and/or processing streams by slurrying with a solution (e.g., aqueous) of the catalyst in a loading tank. When slurried with a solution of the catalyst and/or co-catalyst, the resulting slurry can be dewatered to provide a catalyst-treated feedstock stream, again typically, as a wet cake. The catalyst solution can be prepared from any catalyst source in the present processes, including fresh or make-up catalyst and recycled catalyst or catalyst solution. Methods for dewatering the slurry to provide a wet cake of the catalyst-treated feedstock stream include filtration (gravity or vacuum), centrifugation, and a fluid press.

In another embodiment, as disclosed in previously incorporated US2010/0168495A1, the carbonaceous particulates are combined with an aqueous catalyst solution to generate a substantially non-draining wet cake, then mixed under elevated temperature conditions and finally dried to an appropriate moisture level.

One particular method suitable for combining a coal particulate and/or a processing stream comprising coal with a hydromethanation catalyst to provide a catalyst-treated feedstock stream is via ion exchange as described in previously incorporated US2009/0048476A1 and US2010/0168494A1. Catalyst loading by ion exchange mechanism can be maximized based on adsorption isotherms specifically developed for the coal, as discussed in the incorporated reference. Such loading provides a catalyst-treated feedstock stream as a wet cake. Additional catalyst retained on the ion-exchanged particulate wet cake, including inside the pores, can be controlled so that the total catalyst target value can be obtained in a controlled manner. The total amount of catalyst loaded can be controlled by controlling the concentration of catalyst components in the solution, as well as the contact time, temperature and method, as disclosed in the aforementioned incorporated references, and as can otherwise be readily determined by those of ordinary skill in the relevant art based on the characteristics of the starting coal.

In another example, one of the carbonaceous particulates and/or processing streams can be treated with the hydromethanation catalyst and a second processing stream can be treated with a second component (see previously incorporated US2007/0000177A1).

The carbonaceous particulates, processing streams, and/or catalyst-treated feedstock streams resulting from the preceding can be blended in any combination to provide the catalyzed second carbonaceous feedstock, provided at least one catalyst-treated feedstock stream is utilized to form the catalyzed second carbonaceous feedstock (31+32). Ultimately, the catalyzed second carbonaceous feedstock (31+32) is passed onto the hydromethanation reactor(s) (200).

Generally, each catalyst loading unit comprises at least one loading tank to contact one or more of the carbonaceous particulates and/or processing streams with a solution comprising at least one hydromethanation catalyst, to form one or more catalyst-treated feedstock streams. Alternatively, the catalytic component may be blended as a solid particulate into one or more carbonaceous particulates and/or processing streams to form one or more catalyst-treated feedstock streams.

Typically, when the hydromethanation catalyst is an alkali metal, it is present in the catalyzed second carbonaceous feedstock in an amount sufficient to provide a ratio of alkali metal atoms to carbon atoms in the particulate composition ranging from about 0.01, or from about 0.02, or from about 0.03, or from about 0.04, to about 0.10, or to about 0.08, or to about 0.07, or to about 0.06.

With some feedstocks, the alkali metal component may also be provided within the catalyzed second carbonaceous feedstock to achieve an alkali metal content of from about 3 to about 10 times more than the combined ash content of the carbonaceous material in the catalyzed second carbonaceous feedstock, on a mass basis.

Suitable alkali metals are lithium, sodium, potassium, rubidium, cesium, and mixtures thereof. Particularly useful are potassium sources. Suitable alkali metal compounds include alkali metal carbonates, bicarbonates, formates, oxalates, amides, hydroxides, acetates, or similar compounds. For example, the catalyst can comprise one or more of sodium carbonate, potassium carbonate, rubidium carbonate, lithium carbonate, cesium carbonate, sodium hydroxide, potassium hydroxide, rubidium hydroxide or cesium hydroxide, and particularly, potassium carbonate and/or potassium hydroxide.

Optional co-catalysts or other catalyst additives may be utilized, such as those disclosed in the previously incorporated references.

The one or more catalyst-treated feedstock streams that are combined to form the catalyzed second carbonaceous feedstock typically comprise greater than about 50%, greater than about 70%, or greater than about 85%, or greater than about 90% of the total amount of the loaded catalyst associated with the catalyzed second carbonaceous feedstock (31+32). The percentage of total loaded catalyst that is associated with the various catalyst-treated feedstock streams can be determined according to methods known to those skilled in the art.

Separate carbonaceous particulates, catalyst-treated feedstock streams, and processing streams can be blended appropriately to control, for example, the total catalyst loading or other qualities of the catalyzed second carbonaceous feedstock (31+32), as discussed previously. The appropriate ratios of the various stream that are combined will depend on the qualities of the carbonaceous materials comprising each as well as the desired properties of the catalyzed second carbonaceous feedstock (31+32). For example, a biomass particulate stream and a catalyzed non-biomass particulate stream can be combined in such a ratio to yield a catalyzed second carbonaceous feedstock (31+32) having a predetermined ash content, as discussed previously.

Any of the preceding catalyst-treated feedstock streams, processing streams, and processed feedstock streams, as one or more dry particulates and/or one or more wet cakes, can be combined by any methods known to those skilled in the art including, but not limited to, kneading, and vertical or horizontal mixers, for example, single or twin screw, ribbon, or drum mixers. The resulting catalyzed second carbonaceous feedstock (31+32) can be stored for future use or transferred to one or more feed operations for introduction into the hydromethanation reactor(s). The catalyzed second carbonaceous feedstock can be conveyed to storage or feed operations according to any methods known to those skilled in the art, for example, a screw conveyer or pneumatic transport.

Further, excess moisture can be removed from the catalyzed second carbonaceous feedstock (31+32). For example, the catalyzed second carbonaceous feedstock (31+32) may be dried with a fluid bed slurry drier (i.e., treatment with superheated steam to vaporize the liquid), or the solution thermally evaporated or removed under a vacuum, or under a flow of an inert gas, to provide a catalyzed second carbonaceous feedstock having a residual moisture content, for example, of about 10 wt % or less, or of about 8 wt % or less, or about 6 wt % or less, or about 5 wt % or less, or about 4 wt % or less.

Catalyst Recovery (300)

Reaction of the catalyzed second carbonaceous feedstock (31+32) under the described conditions generally provides the methane-enriched raw product stream (50) and a solid char by-product (52) from the hydromethanation reactor (200). The solid char by-product (52) typically comprises quantities of unreacted carbonaceous material and entrained catalyst. The solid char by-product (52) can be removed from the hydromethanation reactor (200) for sampling, purging, and/or catalyst recovery via a char outlet.

The term “entrained catalyst” as used herein means chemical compounds comprising a the catalytically active portion of the hydromethanation catalyst, such as an alkali metal component. For example, “entrained catalyst” can include, but is not limited to, soluble alkali metal compounds (such as alkali carbonates, alkali hydroxides, and alkali oxides) and/or insoluble alkali compounds (such as alkali aluminosilicates). The nature of catalyst components associated with the char extracted from a catalytic gasifier and methods for their recovery are discussed in detail in previously incorporated US2007/0277437A1, US2009/0165383A1, US2009/0165382A1, US2009/0169449A1 and US2009/0169448A1.

The solid char by-product (52) can be periodically withdrawn from the hydromethanation reactor (200) through a char outlet which is a lock hopper system, although other methods are known to those skilled in the art. Methods for removing solid char product are well known to those skilled in the art. One such method taught by EP-A-0102828, for example, can be employed.

The char by-product (52) from the hydromethanation reactor (200) may be passed to a catalytic recovery unit (300), as described below. Such char by-product (52) may also be split into multiple streams, one of which may be passed to a catalyst recovery unit (300), and another stream (54) which may be used, for example, as a methanation catalyst (as described above) and not treated for catalyst recovery.

In certain embodiments, when the hydromethanation catalyst is an alkali metal, the alkali metal in the solid char by-product (52) can be recovered to produce a catalyst recycle stream (56), and any unrecovered catalyst can be compensated by a catalyst make-up stream (58). The more alumina and silica that is in the feedstock, the more costly it is to obtain a higher alkali metal recovery.

In one embodiment, the solid char by-product (52) from the hydromethanation reactor (200) can be quenched with a recycle gas and water to extract a portion of the entrained catalyst. The recovered catalyst (56) can be directed to the catalyst loading unit (350) for reuse of the alkali metal catalyst. The depleted char (59) can, for example, be directed to any one or more of the feedstock preparation operations (90) for reuse as recycle depleted char (59a) in preparation of the catalyzed feedstock, combusted to power one or more steam generators (such as disclosed in previously incorporated US2009/0165376A1 and US2009/0217585A1), or used as such in a variety of applications, for example, as an absorbent (such as disclosed in previously incorporated US2009/0217582A1).

Other particularly useful recovery and recycling processes are described in U.S. Pat. No. 4,459,138, as well as previously incorporated US2007/0277437A1, US2009/0165383A1, US2009/0165382A1, US2009/0169449A1 and US2009/0169448A1. Reference can be had to those documents for further process details.

The recycle of catalyst can be to one or a combination of catalyst loading processes. For example, all of the recycled catalyst can be supplied to one catalyst loading process, while another process utilizes only makeup catalyst. The levels of recycled versus makeup catalyst can also be controlled on an individual basis among catalyst loading processes.

### Multi-Train Processes

In the processes of the invention, each process may be performed in one or more processing units. For example, one or more hydromethanation reactors may be supplied with the carbonaceous feedstock from one or more catalyst loading and/or feedstock preparation unit operations. Similarly, the methane-enriched raw product streams generated by one or more hydromethanation reactors may be processed or purified separately or via their combination at a heat exchanger, sulfur-tolerant catalytic methanator, acid gas removal unit, trim methanator, and/or methane removal unit depending on the particular system configuration, as discussed, for example, in previously incorporated US2009/0324458A1, US2009/0324459A1, US2009/0324460A1, US2009/0324461A1 and US2009/0324462A1.

In certain embodiments, the processes utilize two or more hydromethanation reactors (e.g., 2-4 hydromethanation reactors). In such embodiments, the processes may contain divergent processing units (i.e., less than the total number of hydromethanation reactors) prior to the hydromethanation reactors for ultimately providing the catalyzed second carbonaceous feedstock to the plurality of hydromethanation reactors, and/or convergent processing units (i.e., less than the total number of hydromethanation reactors) following the catalytic gasifiers for processing the plurality of methane-enriched raw product streams generated by the plurality of hydromethanation reactors.

For example, the processes may utilize (i) divergent catalyst loading units to provide the catalyzed second carbonaceous feedstock to the hydromethanation reactors; (ii) divergent carbonaceous materials processing units to provide a carbonaceous particulate to the catalyst loading units; (iii) convergent heat exchangers to accept a plurality of methane-enriched raw product streams from the hydromethanation reactors; (iv) convergent sulfur-tolerant methanators to accept a plurality of cooled methane-enriched raw product streams from the heat exchangers; (v) convergent acid gas removal units to accept a plurality of cooled methane-enriched raw product gas streams from the heat exchangers or methane-enriched gas streams from the sulfur-tolerant methanators, when present; or (vi) convergent catalytic methanators or trim methanators to accept a plurality of sweetened gas streams from acid gas removal units.

When the systems contain convergent processing units, each of the convergent processing units can be selected to have a capacity to accept greater than a 1/n portion of the total gas stream feeding the convergent processing units, where n is the number of convergent processing units. For example, in a process utilizing 4 hydromethanation reactors and 2 heat exchangers for accepting the 4 methane-enriched raw product streams from the hydromethanation reactors, the heat exchanges can be selected to have a capacity to accept greater than ½ of the total gas volume (e.g., ½ to ¾) of the 4 gas streams and be in communication with two or more of the hydromethanation reactors to allow for routine maintenance of the one or more of the heat exchangers without the need to shut down the entire processing system.

Similarly, when the systems contain divergent processing units, each of the divergent processing units can be selected to have a capacity to accept greater than a 1/m portion of the total feed stream supplying the convergent processing units, where m is the number of divergent processing units. For example, in a process utilizing 2 catalyst loading units and a single carbonaceous material processing unit for providing the carbonaceous particulate to the catalyst loading units, the catalyst loading units, each in communication with the carbonaceous material processing unit, can be selected to have a capacity to accept ½ to all of the total volume of carbonaceous particulate from the single carbonaceous material processing unit to allow for routine maintenance of one of the catalyst loading units without the need to shut down the entire processing system.

### Modification of Existing Syngas Facility

The third aspect of the present invention relates to a process for generating a methane product stream which involves adding a hydromethanation reactor to an existing syngas production facility, especially one that is already structured for producing methane and/or hydrogen as a product. Upon solids and ammonia removal, a methane-enriched raw product stream from a hydromethanation reactor should be fully compatible with gas processing facilities at conventional gasification facilities.

The result is an advantageous ability to add capacity to an existing syngas facility, which additional capacity is more efficient for methane production, and which does not significantly disrupt syngas production available for other products.

As the modified facility will produce both a methane-enriched raw product stream and a syngas raw product stream, the hydromethanation reactor will not utilize all of the syngas capacity of the syngas generator. The hydromethanation reaction thus has a demand for carbon monoxide and hydrogen that is less than the syngas generator has a capacity to generate.

When the hydromethanation reactor is further configured to receive the second oxygen-rich stream, that has a further process advantage in that an air separation unit supplying both the syngas generator and the hydromethanation reactor can be run more efficiently.

We claim:

1. A process for generating a methane-enriched raw product stream and a syngas raw product stream from one or more carbonaceous feedstocks, the process comprising the steps of:
(a) supplying a first carbonaceous feedstock, a first oxygen-rich gas stream, and optionally an aqueous stream comprising one or both of water and steam, to a syngas generator;
(b) reacting the first carbonaceous feedstock in the presence of oxygen and optionally the aqueous stream, in the syngas generator to produce a first gas stream at a first temperature and a first pressure, the first gas stream comprising hydrogen, carbon monoxide, heat energy and optionally steam;
(c) introducing the first gas stream into a first heat exchanger unit, optionally with a quench stream comprising one or both of water and steam, to remove heat energy and generate a cooled first gas stream at a second temperature and a second pressure, the cooled first gas stream comprising hydrogen, carbon monoxide and optionally steam;
(d) separating the cooled first gas stream into a hydromethanation gas feed stream and the syngas raw product stream, the syngas raw product stream comprising carbon monoxide, hydrogen and optionally steam;
(e) optionally adding one or both of steam and heat energy to the hydromethanation gas feed stream such that the resulting hydromethanation gas feed stream comprises hydrogen, carbon monoxide and steam at a third temperature and a third pressure;
(f) introducing a second carbonaceous feedstock, a hydromethanation catalyst, the hydromethanation gas feed stream and optionally a second oxygen-rich gas stream, to a hydromethanation reactor;
(g) reacting the second carbonaceous feedstock in the hydromethanation reactor in the presence of carbon monoxide, hydrogen, steam, hydromethanation catalyst and optionally oxygen, at a fourth temperature and a fourth pressure, to produce the methane-enriched raw product stream, wherein the methane-enriched raw product stream comprises methane, carbon monoxide, hydrogen, carbon dioxide, hydrogen sulfide and heat energy; and
(h) withdrawing the methane-enriched product stream from the hydromethanation reactor,
wherein:
the reaction in step (g) has a syngas demand, a steam demand and a heat demand;
the amount of carbon monoxide and hydrogen in the hydromethanation gas feed stream (or the superheated hydromethanation gas feed stream if present) is sufficient to at least meet the syngas demand of the reaction in step (g);
if the amount of steam in the hydromethanation gas feed stream from step (d) is insufficient to meet the steam demand of the reaction in step (g), then step (e) is present and steam is added to the hydromethanation gas feed stream in an amount that is sufficient to at least meet the steam demand of the reaction in step (g);
if the second temperature is insufficient to meet the heat demand of the reaction in step (g), then step (e) is present and heat energy is added to the hydromethanation gas feed stream in an amount that is at least sufficient to meet the heat demand of the reaction in step (g).

2. The process of claim 1, wherein the methane-enriched raw product stream comprises at least about 20 mol % methane (based on the moles of methane, carbon dioxide, carbon monoxide and hydrogen in the methane-enriched raw product stream).

3. The process of claim 2, wherein the methane-enriched raw product stream comprises at least 50 mol % methane plus carbon dioxide (based on the moles of methane, carbon dioxide, carbon monoxide and hydrogen in the methane-enriched raw product stream).

4. The process of claim 1, wherein steam is supplied to the syngas generator, and the first gas stream further comprises steam.

5. The process of claim 1, wherein the second carbonaceous feedstock is loaded with hydromethanation catalyst prior to being supplied to the hydromethanation reactor.

6. The process of claim 1, wherein the hydromethanation catalyst comprises an alkali metal.

7. The process of claim 1, wherein a char by-product is generated in step (g), and is continuously or periodically withdrawn from the hydromethanation reactor.

8. The process of claim 7, wherein the hydromethanation catalyst comprises an alkali metal, the char by-product comprises an alkali metal content from the hydromethanation catalyst, at least a portion of the char by-product is treated to recover at least a portion of the alkali metal content, and at least a portion of the recovered alkali metal content is recycled for use as hydromethanation catalyst.

9. The process of claim 8, wherein the second carbonaceous feedstock is impregnated with hydromethanation catalyst prior to being supplied to the hydromethanation reactor, and the hydromethanation catalyst used to impregnate the second carbonaceous feedstock comprises recycled hydromethanation catalyst and a make-up hydromethanation catalyst.

10. The process of claim 1, wherein the first and second carbonaceous feedstocks derive from the same carbonaceous material.

11. The process of claim 1, which is a continuous process in which steps (a), (b), (c), (d), (g) and (h), and when present step (e), are performed in a continuous manner.

12. The process of claim 1, further comprising the step of processing the methane-enriched raw product stream to generate a pipeline-quality natural gas product.

13. The process of claim 1, wherein the methane-enriched raw product stream and at least a portion of the syngas raw product stream are treated in a gas processing system to produce a sweetened gas stream.

14. The process of claim 13, wherein the sweetened gas stream is further processed to produce a methane product stream and/or a hydrogen product stream.

15. The process of claim 1, wherein the first carbonaceous feedstock comprises an ash content, the first gas stream comprises a residue from the ash content, and the residue from the ash content is substantially removed prior to introduction of the hydromethanation gas feed stream into the hydromethanation reactor.

16. A gasifier apparatus for generating a methane-enriched raw product stream and a syngas raw product stream from one or more carbonaceous feedstocks, the gasifier apparatus comprising:
(a) a syngas generator configured (1) to receive a first carbonaceous feedstock, a first oxygen-rich gas stream and, optionally an aqueous stream comprising one or both of water and steam; (2) to contain a reaction of the first carbonaceous feedstock in the presence of oxygen and optionally the aqueous stream, that produces a first gas stream comprising hydrogen, carbon monoxide and optionally steam, at a first temperature and a first pressure, and (3) to exhaust the first gas stream;
(b) a cooling zone configured to (1) receive the first gas stream and, optionally, a quench stream comprising one or both of steam and water, and (2) generate a cooled first gas stream comprising hydrogen, carbon monoxide and, optionally, steam at a second temperature and a second pressure;
(c) a separation zone configured to (1) receive the cooled first gas stream, and (2) separate the cooled first gas stream into a hydromethanation gas feed stream and the syngas raw product stream, the syngas raw product stream comprising carbon monoxide, hydrogen and optionally steam;
(d) an optional superheater zone configured to (1) receive the hydromethanation gas feed stream from the separation zone, (2) optionally receive a steam feed stream, and (3) generate a superheated hydromethanation gas feed stream comprising carbon monoxide, hydrogen and steam at a third temperature and a third pressure; and
(e) a hydromethanation reactor configured (1) to receive a second carbonaceous feedstock, a hydromethanation catalyst, the hydromethanation gas feed stream and, optionally, a second oxygen-rich gas stream, the second carbonaceous feedstock comprising a carbon content; (2) to contain a reaction of the second carbonaceous feedstock in the presence of carbon monoxide, hydrogen, steam, hydromethanation catalyst and optionally oxygen, at a fourth temperature and a fourth pressure, that produces a methane-enriched raw product stream, the methane-enriched raw product stream comprising methane, carbon monoxide, hydrogen and carbon dioxide; and (3) to exhaust the methane-enriched raw product stream.

17. A process for generating a sweetened gas stream from one or more carbonaceous feedstocks, the sweetened gas stream comprising methane, hydrogen and optionally carbon monoxide with substantially no carbon dioxide and hydrogen sulfide, the process comprising the steps of:
(A) providing an existing facility comprising (i) a syngas generator that produces a first gas stream comprising carbon monoxide and hydrogen, and optionally carbon dioxide, hydrogen sulfide and steam, at a first temperature and pressure, and (ii) a gas processing system comprising an acid gas removal unit for removing substantially all of the carbon dioxide and hydrogen sulfide that may be present in the first gas stream, wherein the syngas generator comprises an exhaust line for the first gas stream that ties into the gas processing system;
(B) modifying the existing facility to produce a modified facility comprising the following modifications:
(1) if the exhaust line does not comprise a cooling zone for cooling the first gas stream to produce a cooled first gas stream at a second temperature and second pressure, inserting such a cooling zone into the exhaust line prior to the gas processing system;
(2) inserting a gas stream splitting mechanism between the cooling zone and the gas processing system, the gas stream splitting mechanism configured to split the cooled first gas stream into a syngas raw product stream and a hydromethanation gas feed stream;
(3) optionally inserting a superheater for the hydromethanation gas feed stream in communication with the gas stream splitting mechanism, the superheater configured to generate a superheated hydromethanation gas feed stream at a third temperature and pressure;
(4) inserting a hydromethanation reactor in communication with the gas stream splitting mechanism (or the superheater if present), wherein the hydromethanation reactor is configured (i) to receive a second carbonaceous feedstock, a hydromethanation catalyst, the hydromethanation gas feed stream and, optionally, an oxygen-rich gas stream; (ii) to contain a reaction of the second carbonaceous feedstock in the presence of carbon monoxide, hydrogen, steam, hydromethanation catalyst and optionally oxygen, at a fourth temperature and a fourth pressure, that produces a methane-enriched raw product stream, the methane-enriched raw product stream comprising methane, carbon monoxide, hydrogen, carbon dioxide, hydrogen sulfide and heat energy; and (iii) to exhaust the methane-enriched raw product stream; and
(5) inserting a line to feed the methane-enriched product stream into the gas processing system;
(C) operating the process according to claim 1 in the modified facility; and
(D) processing the methane-enriched product stream and, optionally, at least a portion of the syngas raw product stream to produce the sweetened gas stream.
